(19) United States
(12) Patent Application Publication
(10) Pub. No.: US 2025/0226392 A1
(43) Pub. Date: Jul. 10, 2025

(54) SURFACE-MODIFIED ELECTRODES, PREPARATION METHODS AND ELECTROCHEMICAL USES

(71) Applicant: HYDRO-QUÉBEC, Montréal (CA)

(72) Inventors: Nicolas DELAPORTE, Montréal (CA); Steve COLLIN-MARTIN, Saint-Hubert (CA)

(21) Appl. No.: 18/681,918

(22) PCT Filed: Aug. 12, 2022
(86) PCT No.: PCT/CA2022/051231

§ 371 Date: Feb. 7, 2024

(30) Foreign Application Priority Data
Aug. 13, 2021 (CA) 3128220

(51) Int. Cl. H01M 4/36; H01M 4/02; H01M 4/62; H01M 4/66; H01M 10/0525

(52) U.S. Cl. CPC H01M 4/366; H01M 4/625; H01M 4/662; H01M 10/0525; H01M 2004/021; H01M 2004/027

(57) ABSTRACT

This technology concerns modifying the surface of an electrode film with a succession of thin layers, for example, each being of 15 microns or less, where the first thin layer comprises an inorganic compound (such as a ceramic) in a solvating polymer, the inorganic compound being present in the first thin layer in an “inorganic compound:solvating polymer” weight ratio in the first thin layer is in the range of from about 1:20 to about 20:1. Electrochemical cells comprising the modified electrodes are also described as well accumulators comprising them.

### RELATED APPLICATION

The present application claims priority, under applicable law, to Canadian patent application number 3,128,220 filed on Aug. 13, 2021, the content of which is incorporated by reference in its entirety and for all purposes.

### TECHNICAL FIELD

This application relates to electrodes comprising an electrode material film having at least one modified surface, to their manufacturing processes and to electrochemical cells comprising them.

### TECHNICAL BACKGROUND

Liquid electrolytes used in lithium-ion batteries are flammable and get slowly degraded to form a passivation layer at the surface of the lithium film or at the interface of the solid electrolyte (SEI for «solid electrolyte interface» or «solid electrolyte interphase») irreversibly consuming lithium, which reduces the coulombic efficiency of the battery. In addition, lithium anodes undergo significant morphological changes during battery cycling and lithium dendrites are formed. As these usually migrate through the electrolyte, they can eventually cause short circuits. Safety concerns and the requirement for higher energy density have spurred research into the development of an all-solid-state lithium rechargeable battery with either a polymer or ceramic electrolyte, both of which being more stable to lithium metal and reducing lithium dendrite growth. Loss of reactivity and poor contact between solid interfaces in these all-solid-state batteries remain a problem, however.

A simple and more industrially applicable method for protecting the lithium surface is to coat its surface with a polymer or a polymer/lithium salt mixture by spraying, dipping, centrifuging or using the so-called doctor blade method (N. Delaporte, et al., Front. Mater., 2019, 6, 267). The selected polymer must be stable to lithium and an ionic conductor at low temperature. In a way, the polymer layer deposited on the lithium surface should be comparable to the solid polymer electrolytes (SPE) generally reported in the literature, which have a low glass transition (T_{g}) in order to remain rubbery at room temperature and to maintain a lithium conductivity similar to that of a liquid electrolyte. To accommodate the deformation of lithium during cycling and, especially to avoid the formation of lithium dendrites, the polymer must have good flexibility and must be characterized by a high Young modulus.

A few examples of polymers used in this type of protecting layer include polyacrylic acid (PAA) (N.-W. Li, et al., Angew. Chem. Int. Ed., 2018, 57, 1505-1509), poly(vinylidene carbonate-co-acrylonitrile) (S. M. Choi et al., J. Power Sources, 2013, 244, 363-368), poly(ethylene glycol) dimethacrylate (Y. M. Lee, et al., J. Power Sources, 2003, 119-121, 964-972), the PEDOT-co-PEG copolymer (G. Ma, et al., J. Mater. Chem. A, 2014, 2, 19355-19359 and I. S. Kang, et al., J. Electrochem. Soc., 2014, 161 (1), A53-A57), the polymer resulting from the direct polymerization of acetylene on lithium (D. G. Belov, et al., Synth. Met., 2006, 156, 745-751), in situ polymerized ethyl α-cyanoacrylate (Z. Hu, et al., Chem. Mater., 2017, 29, 4682-4689), and a polymer formed from the copolymer Kynar™ 2801 and the curable monomer 1,6-hexanediol diacrylate (N.-S. Choi, et al., Solid State Ion., 2004, 172, 19-24). The latter group also studied the incorporation of an ionic receptor into the polymer mixture (N.-S. Choi, et al., Electrochem. Commun., 2004, 6, 1238-1242).

Some studies have been performed on the incorporation of solid fillers, typically ceramics, into a polymer for lithium surface modification. For example, inorganic fillers (e.g., Al₂O₃, TiO₂, BaTiO₃) have been mixed with a polymer to give a hybrid organic-inorganic composite electrolyte.

A mixture of freshly synthesized spherical Cu₃N particles less than 100 nm in size and a styrene butadiene rubber (SBR) copolymer was applied by doctor blade on the lithium surface (Y. Liu, et al., Adv. Mater., 2017, 29, 1605531). Upon contact with lithium, Cu₃N is converted to highly lithium-conductive Li₃N. Li₄Ti₅O₁₂/Li (LTO/Li) cells were assembled with a liquid electrolyte and better electrochemical performance was obtained using lithium protected by a mixture of Cu₃N and SBR.

A 20 μm protective layer composed of Al₂O₃ particles (1.7 μm average diameter) and polyvinylidene fluoride-hexafluoropropylene (PVDF-HFP) deposited on the lithium surface has been proposed to improve the lifetime of lithium-oxygen batteries (D. J. Lee, et al., Electrochem. Commun., 2014, 40, 45-48). Co₃O₄-Super P/Li batteries with this protective layer and a liquid electrolyte. The effect of similarly modified lithium has also been studied by Gao and his colleagues (H. K. Jing et al., J. Mater. Chem. A, 2015, 3, 12213-12219), although the focus has been on improving lithium-sulfur batteries. In this example, 100 nm Al₂O₃ spheres were used with PVDF as a binder and the mixture prepared in a DMF solvent was spin-coated onto a lithium foil. Battery assembly was then performed with a liquid electrolyte.

A 25 μm porous layer of polyimide with Al₂O₃ as filler (particles size of about 10 nm) in order to limit the growth of lithium was also proposed (see Z. Peng et al., J. Mater. Chem. A, 2016, 4, 2427-2432). This method includes the formation of a film called “skin layer” by contacting lithium with an additive present in the liquid electrolyte (such as fluoroethylene carbonate (FEC), vinylene carbonate (VC) or hexamethylene diisocyanate (HDI)). Cu/LiFePO₄ electrochemical cells comprising this liquid electrolyte were tested to demonstrate the utility of the polyimide/Al₂O₃ layer in inhibiting dendrite formation and electrolyte degradation.

The protective layers described in the three previous paragraphs are porous and suitable for use with a liquid electrolyte, which can penetrate them. This type of layer is therefore not suitable for use with a solid electrolyte, which must be capable of being in intimate contact with the surface of the electrode (or its protective layer) and allow the conduction of ions from the electrolyte to the active electrode material.

### SUMMARY

According to a first aspect, the present technology relates to an electrode comprising an electrode film modified with a first thin layer and a second thin layer, wherein:
the electrode film comprises a first and a second surface, the first surface being optionally pretreated;
the first thin layer comprises an inorganic compound in a solvating polymer and optionally an ionic salt and/or un plasticizer, the first thin layer being disposed on the first surface of the electrode film and having an average thickness of about 15 μm or less, the weight ratio “inorganic compound:solvating polymer” in the first thin layer is in the range from about 1:20 to about 20:1; and
the second thin layer comprises a solvating polymer, an ionic salt and optionally a plasticizer, the second thin layer being disposed on the first thin layer and having an average thickness of about 15 μm or less;
   wherein the solvating polymer of the first layer is identical to or different from the solvating polymer of the second layer.

In one embodiment, the solvating polymer of the first thin layer is crosslinked, and/or the solvating polymer of the second thin layer is crosslinked. In another embodiment, the solvating polymer of the first thin layer is non-crosslinked, and/or the solvating polymer of the second thin layer is non-crosslinked.

According to one embodiment, the electrode film is a current collector, for example comprising an electron-conducting solid support, such as a metal foil or grid (such as copper, nickel, etc.), a carbon or carbon-containing film (such as carbon paper, self-supported graphene, etc.), or other solid support (polymer, glass, etc.) comprising an electron-conducting layer (such as a current collector print).

According to another embodiment, the electrode film comprises a metal film, for example comprising lithium (e.g. comprising less than 1000 ppm (or less than 0.1% by weight) of impurities), or an alloy comprising lithium. In one embodiment, the metal film comprises an alloy of lithium and an element selected from alkali metals other than lithium (such as Na, K, Rb, and Cs), alkaline earth metals (such as Mg, Ca, Sr, and Ba), rare earth metals (such as Sc, Y, La, Ce, Pr, Nd, Sm, Eu, Gd, Tb, Dy, Ho, Er, Tm, Yb, Lu), zirconium, copper, silver, bismuth, cobalt, manganese, zinc, aluminum, silicon, tin, antimony, cadmium, mercury, lead, molybdenum, iron, boron, indium, thallium, nickel and germanium (e.g. Zr, Cu, Ag, Bi, Co, Zn, Al, Si, Sn, Sb, Cd, Hg, Pb, Mn, B, In, TI, Ni, or Ge). According to one embodiment, the alloy comprises at least 75% by weight of lithium, or between 85% and 99.9% by weight of lithium.

According to a further embodiment, the electrode film further comprises a pretreatment layer on the first surface, which is in contact with the first thin layer. In one embodiment, the pretreatment layer comprises a compound selected from a silane, a phosphonate, a borate, an organic salt or compound, a carbon (such as graphite, graphene, etc.), an inorganic salt or compound (such as LiF, Li₃N, Li₃P, LiNO₃, Li₃PO₄, etc.), or a thin layer of an element different from a metal of the electrode film or forming an alloy therewith at the surface (such as an element defined above with reference to alloys), said pretreatment layer having an average thickness of less than 5 μm, or less than 3 μm, or less than 1 μm, or less than 500 nm, or less than 200 nm, or less than 100 nm, or less than 50 nm. In one embodiment, the first surface of the electrode film is pretreated by stamping.

According to one embodiment, the inorganic compound is in particle form (e.g. spherical, rod-shaped, needle-shaped, etc.). For example, the average particle size may be less than 1 μm, or less than 500 nm, or less than 300 nm, or less than 200 nm, or between 1 nm and 500 nm, or between 10 nm and 500 nm, or between 50 nm and 500 nm, or between 100 nm and 500 nm, or between 1 nm and 300 nm, or between 10 nm and 300 nm, or between 50 nm and 300 nm, or between 100 nm and 300 nm, or between 1 nm and 200 nm, or between 10 nm and 200 nm, or between 50 nm and 200 nm, or between 100 nm and 200 nm, or between 1 nm and 100 nm, or between 10 nm and 100 nm, or between 25 nm and 100 nm, or between 50 nm and 100 nm.

In another embodiment, the inorganic compound comprises a ceramic. In one embodiment, the inorganic compound is selected from Al₂O₃, Mg₂B₂O₅, Na₂O·2B₂O₃, xMgO·yB₂O₃·zH₂O, TiO₂, ZrO₂, ZnO, Ti₂O₃, SiO₂, Cr₂O₃, CeO₂, B₂O₃, B₂O, SrBi₄Ti₄O₁₅, LLTO, LLZO, LAGP, LATP, Fe₂O₃, BaTiO₃, γ-LiAlO₂, a metal/carbon mixture (such as Sn+C, Zn+C, Ni₂P+C), molecular sieves and zeolites (e.g., of aluminosilicate, of mesoporous silica), sulfide ceramics (like Li₇P₃S₁₁), glass ceramics (such as LIPON, etc.), and other ceramics, and their combinations.

According to an additional embodiment, the particles of the inorganic compound further comprise organic groups covalently grafted on their surface, for example, said groups being selected from crosslinkable groups (such as organic groups comprising acrylate functions, methacrylate functions, vinyl functions, glycidyl functions, mercapto functions, etc.), aryl groups, alkylene oxide or poly(alkylene oxide) groups, and other organic groups, or a combination thereof, optionally comprising a spacer group between the organic groups and the particles of inorganic compound. In one embodiment, the grafted organic groups comprise poly(alkylene oxide) chains attached to the inorganic compound particles by a spacer group. In another embodiment, the spacer group is selected from silane or halogenated silane, phosphonate, carboxylate, catechol, (meth)acrylate or poly(meth)acrylate, alkylene or polyalkylene groups, and combinations thereof.

According to one embodiment, the inorganic compound particles have a small specific surface area (for example, less than 80 m²/g, or less then 40 m²/g). According to another embodiment, the “inorganic compound:solvating polymer” weight ratio in the first thin layer is in the range from about 2:5 to about 4:1, or from about 2:5 to about 2:1, or from about 1:2 to about 2:1, or from about 4:5 to about 2:1, or from about 1:1 to about 2:1, or from about 4:5 to about 3:2. In yet another embodiment, the inorganic compound particles have a high specific surface area (for example, of 80 m²/g or more, or of 120 m²/g or more). In yet another embodiment, the “inorganic compound:solvating polymer” weight ratio in the first thin layer is in the range from about 1:20 to about 2:1, or from about 2:5 to about 2:1, from about 2:5 to about 6:5, or from about 1:20 to about 6:5, or from about 2:5 to about 1:1, or from about 1:20 to about 1:1, or from about 2:5 to about 4:5, or from about 1:20 to about 4:5.

According to an additional embodiment, the average thickness of the first thin layer is between about 0.5 μm and about 15 μm, or between about 1 μm and about 15 μm, or between about 1 μm and about 12 μm, or between about 0.5 μm and about 10 μm, or between about 1 μm and about 10 μm, or between about 2 μm and about 8 μm, or between about 2 μm and about 7 μm, or between 2 μm and about 5 μm. According to another embodiment, the average thickness of the second thin layer is between about 50 nm and about 15 μm, or between about 0.1 μm and about 15 μm, or between about 0.5 μm and about 15 μm, or between about 1 μm and about 15 μm, or between about 1 μm and about 12 μm, or between about 0.5 μm and about 10 μm, or between about 1 μm and about 10 μm, or between about 2 μm and about 8 μm, or between about 2 μm and about 7 μm, or between about 2 μm and about 5 μm, or between about 50 nm and about 5 μm, or between about 0.1 μm and about 2 μm. In yet another embodiment, the total average thickness of the first and second thin layers is in the range from about 1 μm to about 30 μm, or from about 1 μm to about 25 μm, or from about 5 μm to about 25 μm, or from about 1 μm to about 20 μm, or from about 1 μm to about 16 μm, or from about 2 μm to about 12 μm, or from about 3 μm to about 15 μm, or from about 3 μm to about 12 μm, or from about 4 μm to about 15 μm, or from about 4 μm to about 12 μm.

According to another embodiment, the solvating polymer is independently selected from linear or branched polyether polymers (e.g. PEO, PPO, or EO/PO copolymer), poly(dimethylsiloxanes), poly(alkylene carbonate), poly(alkylene sulfones), poly(alkylene sulfamides), polyurethanes, polyvinyl alcohols, polyacrylonitriles, poly(methyl methacrylates), and copolymers thereof, optionally comprising crosslinked units derived from crosslinkable functions (such as acrylate functions, methacrylate functions, vinyl functions, glycidyl functions, mercapto functions, etc.).

According to a preferred embodiment, at least one of the first and second thin layers further comprises a plasticizer, for example, the first thin layer and the second thin layer further comprise a plasticizer. In one embodiment, the plasticizer is selected the liquids of the type glycol diethers (such as tetraethylene glycol dimethyl ether (TEGDME)), carbonate esters (such as propylene carbonate, ethylene carbonate, fluoroethylene carbonate), lactones (such as γ-butyrolactone), adiponitrile, ionic liquids and the like.

According to a further embodiment, at least one of the first and second thin layers further comprises a lithium salt. In one embodiment, the first thin layer and the second thin layer further comprise a lithium salt. In another embodiment, the lithium salt is selected from lithium hexafluorophosphate (LiPF₆), lithium bis(trifluoromethanesulfonyl)imide (LiTFSI), lithium bis(fluorosulfonyl)imide (LiFSI), lithium 2-trifluoromethyl-4,5-dicyano-imidazolate (LiTDI), lithium 4,5-dicyano-1,2,3-triazolate (LiDCTA), lithium bis(pentafluoroethylsulfonyl)imide (LiBETI), lithium tetrafluoroborate (LiBF₄), lithium bis(oxalato)borate (LiBOB), lithium nitrate (LiNO₃), lithium chloride (LiCl), lithium bromide (LiBr), lithium fluoride (LiF), lithium perchlorate (LiClO₄), lithium hexafluoroarsenate (LiAsF₆), lithium trifluoromethanesulfonate (LiSO₃CF₃) (LiTf), lithium fluoroalkylphosphate Li[PF₃(CF₂CF₃)₃] (LiFAP), lithium tetrakis(trifluoroacetoxy)borate Li[B(OCOCF₃)₄] (LiTFAB), lithium bis(1,2-benzenediolato(2-)-O,O′)borate Li[B(C₆O₂)₂] (LBBB), and a combination thereof.

According to another embodiment of the first aspect, the electrode further comprises a current collector in contact with the second surface of the electrode film.

According to a second aspect, the present technology relates to an electrochemical cell comprising a negative electrode and a positive electrode, wherein at least one of the negative electrode and the positive electrode is as defined above. In one embodiment, the negative electrode is as defined above and the positive electrode comprises a film of positive electrode material comprising a positive electrode electrochemically active material, optionally a binder, and optionally an electronically conductive material.

According to one embodiment, the positive electrode electrochemically active material is selected from metal phosphates, lithiated metal phosphates, metal oxides and lithiated metal oxides. In another embodiment, the positive electrode electrochemically active material is LiM′PO₄ where M′ is Fe, Ni, Mn, Co, or a combination thereof, LiV₃O, V₂O₅F, LiV₂O₅, LiMn₂O₄, LiM″O₂, where M″ is Mn, Co, Ni, or a combination thereof (such as NMC, LiMnₓCo_{y}Ni_{z}O₂ with x+y+z=1), Li(NiM′″)O₂ (where M′″ is Mn, Co, Al, Fe, Cr, Ti, Zr, or a combination thereof), elemental sulfur, elemental selenium, elemental iodine, iron(III) fluoride, copper(II) fluoride, lithium iodide, carbon based active materials, organic cathode active materials (such as polyimide, poly(2,2,6,6-tetramethylpiperidinyloxy-4-yl methacrylate) (PTMA), tetra-lithium perylene-3,4,9,10-tetracarboxylate (PTCLi₄), naphthalene-1,4,5,8-tetracarboxylic dianhydride (NTCDA), perylene-3,4,9,10-tetracarboxylic dianhydride (PTCDA), π-conjugated dicarboxylates, and anthraquinone), or a combination of two or more of these materials if compatible with each other.

In another embodiment, the positive electrode electrochemically active material is in the form of optionally coated particles (e.g. with polymer, ceramic, carbon, or a combination of two or more thereof).

In a further embodiment, the film of positive electrode material comprises a first and a second surfaces, the first surface facing the negative electrode and carrying a third thin layer comprising a solvating polymer and an ionic salt, the third thin layer having an average thickness of about 50 μm or less, about 40 μm or less, or about 30 μm or less, or about 15 μm or less, or is between about 0.5 μm and about 50 μm, or between about 5 μm and about 50 μm, or between about 5 μm and about 40 μm, or between about 0.5 μm and about 15 μm, or between about 1 μm and about 15 μm, or between about 1 μm and about 12 μm, or between about 0.5 μm and about 10 μm, or between about 1 μm and about 10 μm, or between about 2 μm and about 8 μm, or between about 2 μm and about 7 μm, or between 2 μm and about 5 μm. In one embodiment, the solvating polymer is as defined above. In another embodiment, the salt is a lithium salt, for example as defined above. According to another embodiment, the third thin layer further comprises a plasticizer, for example as defined above.

According to one embodiment of the second aspect, the electrochemical cell excludes the presence of a solid polymer electrolyte layer.

According to an alternative embodiment of the second aspect, the electrochemical cell further comprises a solid electrolyte layer comprising a polymer and a lithium salt. In one embodiment, the electrolyte polymer is selected from linear or branched polyether polymers (for example, PEO, PPO, or EO/PO copolymer), and optionally comprising crosslinkable units), poly(dimethylsiloxanes), poly(alkylene carbonates), poly(alkylene sulfones), poly(alkylene sulfamides), polyurethanes, poly(vinyl alcohols), polyacrylonitriles, poly(methyl methacrylates), and copolymers thereof, the solvating polymer being optionally crosslinked.

In another embodiment, the lithium salt of the solid electrolyte layer is selected from lithium hexafluorophosphate (LiPF₆), lithium bis(trifluoromethanesulfonyl)imide (LiTFSI), lithium bis(fluorosulfonyl)imide (LiFSI), lithium 2-trifluoromethyl-4,5-dicyano-imidazolate (LiTDI), lithium 4,5-dicyano-1,2,3-triazolate (LiDCTA), lithium bis(pentafluoroethylsulfonyl)imide (LiBETI), lithium tetrafluoroborate (LiBF₄), lithium bis(oxalato)borate (LiBOB), lithium nitrate (LiNO₃), lithium chloride (LiCl), lithium bromide (LiBr), lithium fluoride (LiF), lithium perchlorate (LiClO₄), lithium hexafluoroarsenate (LiAsF₆), lithium trifluoromethanesulfonate (LiSO₃CF₃) (LiTf), lithium fluoroalkylphosphate Li[PF₃(CF₂CF₃)₃] (LiFAP), lithium tetrakis(trifluoroacetoxy)borate Li[B(OCOCF₃)₄] (LiTFAB), lithium bis(1,2-benzenediolato(2-)-O,O′)borate Li[B(C₆O₂)₂] (LBBB), and a combination thereof.

According to another embodiment, the solid electrolyte further comprises a ceramic.

According to a third aspect, the present technology relates to an electrochemical cell comprising a negative electrode and a positive electrode, wherein:
(a) the negative electrode comprises a negative electrode film comprising a first and a second surface, the first surface being optionally pretreated, wherein said negative electrode comprises a first thin layer comprising an inorganic compound in a solvating polymer and optionally an ionic salt and/or a plasticizer, the first thin layer being disposed on the first surface of the negative electrode film and having an average thickness of about 15 μm or less, the “inorganic compound:solvating polymer” weight ratio in the first thin layer is in the range of about 1:20 to about 20:1; and
(b) the negative electrode comprises a second thin layer comprising a solvating polymer, an ionic salt and optionally a plasticizer, the second thin layer being disposed on the first thin layer and having an average thickness of about 15 μm or less, wherein the solvating polymer of the first layer is the same as or different from the solvating polymer of the second layer; and/or
the positive electrode comprises a positive electrode material film comprising a positive electrode electrochemically active material, optionally a binder, and optionally an electronically conductive material, the positive electrode material film comprising a first and a second surface, the first surface facing the negative electrode and carrying a third thin layer comprising a solvating polymer, an ionic salt, the third thin layer having an average thickness of about 50 μm or less;
   wherein the electrochemical cell excludes the presence of an additional solid polymer electrolyte layer.

According to one embodiment, the electrochemical cell comprises the second thin layer, the solvating polymer of the second thin layer being crosslinked or non-crosslinked. According to another embodiment, the electrochemical cell comprises the third thin layer, the solvating polymer of the third thin layer being crosslinked or non-crosslinked. According to one example, the electrochemical cell comprises the second thin layer and the third thin layer.

In one embodiment, the solvating polymer of the first thin layer is crosslinked. In an alternative embodiment, the solvating polymer of the first thin layer is non-crosslinked.

According to one embodiment, the negative electrode film is a current collector, for example comprising an electron-conducting solid support, such as a metal foil or grid (such as copper, nickel, etc.), a carbon or carbon-containing film (such as carbon paper, self-supported graphene, etc.), or other solid support (polymer, glass, etc.) comprising an electron-conducting layer (such as a current collector print).

According to another embodiment, the negative electrode film comprises a metal film, for example comprising lithium or an alloy comprising lithium. According to one embodiment, the metal film comprises lithium comprising less than 1000 ppm (or less than 0.1% by weight) of impurities. According to another embodiment, the metal film comprises an alloy of lithium and an element selected from alkali metals other than lithium (such as Na, K, Rb, and Cs), alkaline earth metals (such as Mg, Ca, Sr, and Ba), rare earth metals (such as Sc, Y, La, Ce, Pr, Nd, Sm, Eu, Gd, Tb, Dy, Ho, Er, Tm, Yb, Lu), zirconium, copper, silver, bismuth, cobalt, manganese, zinc, aluminum, silicon, tin, antimony, cadmium, mercury, lead, molybdenum, iron, boron, indium, thallium, nickel and germanium (e.g. Zr, Cu, Ag, Bi, Co, Zn, Al, Si, Sn, Sb, Cd, Hg, Pb, Mn, B, In, TI, Ni, or Ge), for instance the alloy may comprise at least 75% by weight of lithium, or between 85% and 99.9% by weight of lithium.

In one embodiment, the negative electrode film further comprises a pretreatment layer on the first surface, which is in contact with the first thin layer. According to one embodiment, the pretreatment layer comprises a compound selected from a silane, a phosphonate, a borate, an organic salt or compound, a carbon (such as graphite, graphene, etc.), an inorganic salt or compound (such as LiF, Li₃N, Li₃P, LiNO₃, Li₃PO₄, etc.), or a thin layer of an element different from the metal of the metal film, or forming an alloy therewith at the surface (such as an element defined above), said pretreatment layer having an average thickness of less than 5 μm, or less than 3 μm, or less than 1 μm, or less than 500 nm, or less than 200 nm, or less than 100 nm, or less than 50 nm. In another embodiment, the first surface of the negative electrode film is pretreated by stamping.

In another embodiment, the inorganic compound is in the form of particles (e.g. spherical, rod-shaped, needle-shaped, etc.), for example, with an average size of less than 1 μm, less than 500 nm, or less than 300 nm, or less than 200 nm, or between 1 nm and 500 nm, or between 10 nm and 500 nm, or between 50 nm and 500 nm, or between 100 nm and 500 nm, or between 1 nm and 300 nm, or between 10 nm and 300 nm, or between 50 nm and 300 nm, or between 100 nm and 300 nm, or between 1 nm and 200 nm, or between 10 nm and 200 nm, or between 50 nm and 200 nm, or between 100 nm and 200 nm, or between 1 nm and 100 nm, or between 10 nm and 100 nm, or between 25 nm and 100 nm, or between 50 nm and 100 nm.

According to one embodiment, the inorganic compound comprises a ceramic. According to another embodiment, the inorganic compound is selected from Al₂O₃, Mg₂B₂O₅, Na₂O·2B₂O₃, xMgO·yB₂O₃·zH₂O, TiO₂, ZrO₂, ZnO, Ti₂O₃, SiO₂, Cr₂O₃, CeO₂, B₂O₃, B₂O, SrBi₄Ti₄O₁S, LLTO, LLZO, LAGP, LATP, Fe₂O₃, BaTiO₃, γ-LiAlO₂, a metal/carbon mixture (such as Sn+C, Zn+C, Ni₂P+C), molecular sieves and zeolites (e.g., of aluminosilicate, of mesoporous silica), sulfide ceramics (like Li₇P₃S₁₁), glass-ceramics (such as LIPON, etc.), and other ceramics, as well as their combinations.

In another embodiment, the particles of the inorganic compound further comprise organic groups covalently grafted onto their surface, for example, said groups being selected from crosslinkable groups (such as organic groups comprising acrylate functions, methacrylate functions, vinyl functions, glycidyl functions, mercapto functions, etc.), aryl groups, alkylene oxide or poly(alkylene oxide) groups, and other organic groups, or a combination thereof, optionally comprising a spacer group between the organic groups and the particles of the inorganic compound. In one embodiment, the grafted organic groups comprise poly(alkylene oxide) chains attached to the inorganic compound particles by a spacer group. For example, the spacer group may be selected from silane or halogenated silane, phosphonate, carboxylate, catechol, (meth)acrylate or poly(meth)acrylate, alkylene or polyalkylene groups, and combinations thereof.

According to one embodiment, the inorganic compound particles have a small specific surface area (for example, less than 80 m²/g, or less than 40 m²/g). According to another embodiment, the “inorganic compound:solvating polymer” weight ratio in the first thin layer is in the range from about 2:5 to about 4:1, or from about 2:5 to about 2:1, or from about 1:2 to about 2:1, or from about 4:5 to about 2:1, or from about 1:1 to about 2:1, or from about 4:5 to about 3:2. In another embodiment, the inorganic compound particles have a high specific surface area (e.g. 80 m²/g and above, or 120 m²/g and above). In yet another embodiment, the “inorganic compound:solvating polymer” weight ratio in the first thin layer is in the range from about 1:20 to about 2:1, or from about 2:5 to about 2:1, from about 2:5 to about 6:5, or from about 1:20 to about 6:5, or from about 2:5 to about 1:1, or from about 1:20 to about 1:1, or from about 2:5 to about 4:5, or from about 1:20 to about 4:5.

According to one embodiment, the average thickness of the first thin layer is between about 0.5 μm and about 15 μm, or between about 1 μm and about 15 μm, or between about 1 μm and about 12 μm, or between about 0.5 μm and about 10 μm, or between about 1 μm and about 10 μm, or between about 2 μm and about 8 μm, or between about 2 μm and about 7 μm, or between 2 μm and about 5 μm.

According to another embodiment, the average thickness of the second thin layer is between about 50 nm and about 15 μm, or between about 0.1 μm and about 15 μm, between about 0.5 μm and about 15 μm, or between about 1 μm and about 15 μm, or between about 1 μm and about 12 μm, or between about 0.5 μm and about 10 μm, or between about 1 μm and about 10 μm, or between about 2 μm and about 8 μm, or between about 2 μm and about 7 μm, or between 2 μm and about 5 μm, or between 50 nm and about 5 μm, or between about 0.1 μm and about 2 μm.

According to yet another embodiment, the second thin layer is present and the total average thickness of the first and second thin layers is in the range from about 1 μm to about 30 μm, or from about 1 μm to about 25 μm, or from about 5 μm to about 25 μm, or from about 1 μm to about 20 μm, or from about 1 μm to about 16 μm, or from about 2 μm to about 12 μm, or from about 3 μm to about 15 μm, or from about 3 μm to about 12 μm, or from about 4 μm to about 15 μm, or from about 4 μm to about 12 μm.

In one embodiment, the average thickness of the third thin layer is about 40 μm or less, or about 30 μm or less, or about 15 μm or less, or between about 0.5 μm and about 50 μm, or between about 5 μm and about 50 μm, or between about 5 μm and about 40 μm, or between about 0.5 μm and about 15 μm, or between about 1 μm and about 15 μm, or between about 1 μm and about 12 μm, or between about 0.5 μm and about 10 μm, or between about 1 μm and about 10 μm, or between about 2 μm and about 8 μm, or between about 2 μm and about 7 μm, or between 2 μm and about 5 μm.

In yet another embodiment, the second thin layer and the third thin layer are present and the total average thickness of the first, second and third thin layers is in the range from about 3 μm to about 60 μm, or from about 10 μm to about 50 μm, or from about 15 μm to about 30 μm, or from about 3 μm to about 30 μm, or from about 3 μm to about 25 μm, or from about 5 μm to about 25 μm, or from about 5 μm to about 20 μm, or from about 8 μm to about 15 μm, or from about 8 μm to about 12 μm, or from about 5 μm to about 15 μm, or from about 5 μm to about 12 μm, or from about 5 μm to about 15 μm, or from about 9 μm to about 15 μm.

According to one embodiment, the solvating polymer is independently selected from linear or branched polyether polymers (e.g. PEO, PPO, or EO/PO copolymer), poly(dimethylsiloxanes), poly(alkylene carbonates), poly(alkylene sulfones), poly(alkylene sulfamides), polyurethanes, poly(vinyl alcohols), polyacrylonitriles, poly(methyl methacrylates), and copolymers thereof, optionally comprising crosslinked units derived from crosslinkable functions (such as acrylate functions, methacrylate functions, vinyl functions, glycidyl functions, mercapto functions, etc.).

According to another embodiment, at least one of the first and second thin layers further comprises a plasticizer, or the first thin layer and the second thin layer further comprise a plasticizer, and/or the third thin layer further comprises a plasticizer. In one embodiment, the plasticizer is selected from liquids of the type glycol diethers (such as tetraethylene glycol dimethyl ether (TEGDME)), carbonate esters (such as propylene carbonate, ethylene carbonate, fluoroethylene carbonate), lactones (such as γ-butyrolactone), adiponitrile, ionic liquids and the like.

According to a further embodiment, at least one of the first, second and third thin layers further comprises a lithium salt, or the first, second and third thin layers further comprise a lithium salt. In one embodiment, the lithium salt is selected from lithium hexafluorophosphate (LiPF₆), lithium bis(trifluoromethanesulfonyl)imide (LiTFSI), lithium bis(fluorosulfonyl)imide (LiFSI), lithium 2-trifluoromethyl-4,5-dicyano-imidazolate (LiTDI), lithium 4,5-dicyano-1,2,3-triazolate (LiDCTA), lithium bis(pentafluoroethylsulfonyl)imide (LiBETI), lithium tetrafluoroborate (LiBF₄), lithium bis(oxalato)borate (LiBOB), lithium nitrate (LiNO₃), lithium chloride (LiCl), lithium bromide (LiBr), lithium fluoride (LiF), lithium perchlorate (LiClO₄), lithium hexafluoroarsenate (LiAsF₆), lithium trifluoromethanesulfonate (LiSO₃CF₃) (LiTf), lithium fluoroalkylphosphate Li[PF₃(CF₂CF₃)₃] (LiFAP), lithium tetrakis(trifluoroacetoxy)borate Li[B(OCOCF₃)₄] (LiTFAB), lithium bis(1,2-benzenediolato(2-)-O,O′)borate Li[B(C₆O₂)₂] (LBBB), and a combination thereof.

According to yet another embodiment, the negative electrode further comprises a current collector in contact with the second surface of the negative electrode film. In one embodiment, the positive electrode further comprises a current collector in contact with the second surface of the positive electrode material film.

According to one embodiment, the positive electrode electrochemically active material is selected from metal phosphates, lithiated metal phosphates, metal oxides, and lithiated metal oxides. In another embodiment, the positive electrode electrochemically active material is LiM′PO₄ where M′ is Fe, Ni, Mn, Co, or a combination thereof, LiV₃O, V₂O₅F, LiV₂O₅, LiMn₂O₄, LiM″O₂, where M″ is Mn, Co, Ni, or a combination thereof (such as NMC, LiMnₓCo_{y}Ni_{z}O₂ with x+y+z=1), Li(NiM′″)O₂ (where M′″ is Mn, Co, Al, Fe, Cr, Ti, Zr, or a combination thereof), elemental sulfur, elemental selenium, elemental iodine, iron(III) fluoride, copper(II) fluoride, lithium iodide, carbon based active materials, organic cathode active materials (such as polyimide, poly(2,2,6,6-tetramethylpiperidinyloxy-4-yl methacrylate) (PTMA), tetra-lithium perylene-3,4,9,10-tetracarboxylate (PTCLi₄), naphthalene-1,4,5,8-tetracarboxylic dianhydride (NTCDA), perylene-3,4,9,10-tetracarboxylic dianhydride (PTCDA), π-conjugated dicarboxylates, and anthraquinone), or a combination of two or more of these materials if compatible with each other. In another embodiment, the positive electrode electrochemically active material is in the form of optionally coated particles (e.g. with polymer, ceramic, carbon or a combination of two or more thereof).

According to a fourth aspect, the present technology relates to an electrochemical accumulator comprising at least one electrochemical cell as defined above. According to one embodiment, the electrochemical accumulator is a lithium battery or a lithium-ion battery.

According to a fifth aspect, the present technology relates to the use of an electrochemical accumulator as defined above, in a mobile device, an electric or hybrid vehicle, or in the storage of renewable energy. According to one embodiment, the mobile device is selected from cell phones, cameras, tablets, and laptops.

### BRIEF DESCRIPTION OF FIGURES

FIG. 1 shows (a) the R-ray diffractogram and (b) a scanning microscope image of the Ni₂P powder (Ni₁₂P₅ phase) obtained according to Example 1(a).

FIG. 2 shows (a) thermogravimetric curves for Al₂O₃ (-) and Al₂O₃-polymer ( - - - ), and (b) a photograph of a lithium strip with a 1 μm thin layer of Polymer 1+Al₂O₃ ceramic-polymer according to Example 1(b).

FIG. 3 shows conductivity measurements between 20° C. and 80° C. on stainless steel of the polymer films A1 to A5 described in Example 2(a).

FIG. 4 schematically illustrates various cell configurations comprising a polymer+inorganic compound layer on the anode and (a) a polymer electrolyte; (b) a polymer layer on the cathode and a polymer electrolyte; (c) a second layer without inorganic compound on the polymer+inorganic compound layer and a polymer electrolyte; (d) an inorganic compound-free second layer on the polymer+inorganic compound layer (without polymer electrolyte); (e) a polymer layer on the cathode (without polymer electrolyte); and (f) an inorganic compound-free second layer on the polymer+inorganic compound layer, a polymer layer on the cathode (without polymer electrolyte).

FIG. 5 shows the results of (a) galvanostatic cycling obtained at 50° C. and C/6 (2 cycles at C/12 every 20 cycles at C/6) for LFP/polymer electrolyte/Li batteries assembled with lithium without modification (reference) and lithiums with layers B₁(i) to B₃(i) according to Example 3(a); and (b) the representation of the capacity drop during cycling for the same batteries.

FIG. 6 shows the results of (a) galvanostatic cycling obtained at 50° C. and C/6 (2 cycles at C/12 every 20 cycles at C/6) for LFP/polymer electrolyte/Li batteries assembled with lithium without modification (reference) and lithiums with layers 1 to B₃ according to Example 3(b); and (b) the representation of the capacity drop during cycling for the same batteries.

FIG. 7 shows the results (a) of galvanostatic cycling obtained at 50° C. and C/6 (2 cycles at C/12 every 20 cycles at C/6) for LFP/polymer electrolyte/Li batteries assembled with lithium without modification (reference) and lithiums having layers 1 to B₃ according to Example 3(c) (with solid percentages of 17, 21, and 24%); and (b) the representation of the capacity drop during cycling for the same batteries.

FIG. 8 shows data on (a) galvanostatic cycling and (b) coulombic efficiencies obtained at 50° C. and C/3 for LFP/polymer electrolyte/Li batteries assembled with lithium without modification (reference) and lithium having a 4 μm layer of Polymer 1 with 130% Al₂O₃-polymer (C1 cells according to Example 3(d)). The scheme shows the assembly of the C1 batteries.

FIG. 9 shows data on (a) galvanostatic cycling and (b) coulombic efficiencies obtained at 50° C. and C/3 for LFP/polymer electrolyte/Li batteries assembled with lithium without modification (reference) and lithium having a 4 μm layer of Polymer 1 with 130% Al₂O₃-polymer and an LFP cathode having a 2 or 4 μm layer of Polymer (C2-a and C2-b cells according to Example 3(d)). The scheme shows the assembly of the C2-a and C2-b cells.

FIG. 10 shows data on (a) galvanostatic cycling and (b) coulombic efficiencies obtained at 50° C. and C/3 for LFP/polymer electrolyte/Li batteries assembled with lithium without modification (reference) and lithium having a 4 μm layer of Polymer 1 with 130% Al₂O₃-polymer and a second 4 μm layer of Polymer 1 (C3 cell according to Example 3(d)). The scheme shows the assembly of the C3 battery.

FIG. 11 shows data on (a) galvanostatic cycling and (b) coulombic efficiencies obtained at 50° C. and C/3 for LFP/polymer electrolyte/Li batteries assembled with an unmodified lithium (reference) and lithium having a 4 μm layer of Polymer 1 with 130% Al₂O₃-polymer and a second 9 or 12 μm layer of Polymer 1 without polymer electrolyte (C4-a and C4-b batteries according to Example 3(d)). The scheme shows the assembly of C4-a and C4-b cells.

FIG. 12 shows data on (a) galvanostatic cycling and (b) coulombic efficiencies obtained at 50° C. and C/3 for LFP/polymer electrolyte/Li batteries assembled with an unmodified lithium (reference) and lithium having a 4 μm layer of Polymer 1 with 130% Al₂O₃-polymer and an LFP cathode having a 5, 8 or 11 μm polymer layer without polymer electrolyte (C5-a, C5-b and C-5-c cells according to Example 3(d)). The scheme shows the assembly of the C5-a, C5-b and C-5-c cells.

FIG. 13 shows data for (a) galvanostatic cycling and (b) coulombic efficiencies obtained at 50° C. and C/3 for LFP/polymer electrolyte/Li batteries assembled with an unmodified lithium (reference) and lithium having a 4 μm layer of Polymer 1 with 130% Al₂O₃-polymer and a second 3 or 4 μm layer of Polymer 1 as well as an LFP cathode having a 4 μm polymer layer, without polymer electrolyte (C6-a and C6-b cells according to Example 3(d)). The scheme shows the assembly of the C6-a and C6-b cells.

FIG. 14 shows the galvanostatic cycling obtained at 50° C. and C/3 for LFP/polymer electrolyte/Li batteries assembled with lithium without modification (reference), then with lithium having a 5 μm layer of polymer 1 with 30% Ni₂P and 17% carbon according to Example 3(e).

FIG. 15 shows data on (a) cycling stability (discharge capacity), (b) average voltage and (c) coulombic efficiencies obtained during galvanostatic cycling at 50° C. and C/3 for two LFP/polymer electrolyte/Li batteries assembled with unmodified lithium (reference) and two C7 batteries as described in Example 4.

FIG. 16 shows data on (a) cycling stability (discharge capacity), and (b) coulombic efficiencies obtained during galvanostatic cycling at 50° C. and C/3 for two LFP/polymer electrolyte/Li batteries assembled with unmodified lithium (reference) and three C8 batteries as described in Example 4.

FIG. 17 shows data on (a) discharge capacity, and (b) coulombic efficiencies obtained during cycling at 50° C. at speeds ranging from C/6 to 1C for an LFP/polymer electrolyte/Li battery assembled with unmodified lithium (reference) and two C9 cells as described in Example 4.

FIG. 18 shows galvanostatic cycling obtained at 50° C. in C/3 (a) and C/6 (b) for LFP/polymer electrolyte/Li batteries assembled with lithium without modification (reference), and with lithiums modified with (a) an inorganic molecule (PCl₃) and (b) a thin metal layer (Zn) according to Example 5.

FIG. 19 shows photographs of lithium strips treated having received (a) a PCl₃ treatment and (b) a PCl₃ treatment followed by a polymer 1+Al₂O₃-polymer deposition according to Example 5.

### DESCRIPTION DÉTAILLÉE

All technical and scientific terms and expressions used herein have the same meaning as that generally understood by the person skilled in the art of this technology. The definition of some of the terms and expressions used are nonetheless provided hereinbelow.

When the term “about” is used here, it means approximately, in the region of, and around. When the term “about” is used in relation to a numerical value, it may modify it, for example, above and below its nominal value by a variation of 10%. This term can also take into account, for example, the experimental error specific to a measuring device or the rounding of a value.

When a range of values is referred to in this application, the lower and upper limits of the range are, unless otherwise specified, always included in the definition. For example, “between x and y”, or “from x to y” means a range in which the x and y limits are included unless otherwise indicated. For example, the range “between 1 and 50” namely includes the values 1 and 50.

The chemical structures described herein are drawn according to the conventions of the field. Also, when an atom, such as a carbon atom, as drawn appears to include an incomplete valence, then it will be assumed that the valence is satisfied by one or more hydrogen atoms even if they are not explicitly drawn.

As used herein, the term “alkyl” refers to saturated hydrocarbon groups having from 1 to 20 carbon atoms, including linear or branched alkyl groups. Non-limiting examples of alkyls may include the groups methyl, ethyl, propyl, butyl, pentyl, hexyl, heptyl, octyl, nonyl, decyl, isopropyl, tert-butyl, sec-butyl, isobutyl, and analogs. Similarly, an “alkylene” group refers to an alkyl group located between two other groups. Examples of alkylene groups include methylene, ethylene, propylene, etc. The terms “C₁-Cₙalkyl” and “C₁-Cₙalkylene” refer to an alkyl or alkylene group having from 1 to “n” number of carbon atoms.

The present document therefore describes the surface modification of an electrode film as well as electrodes comprising this modified electrode film. More specifically, the surface of the electrode film is modified by a stack of at least two thin layers, each about 15 μm thick or less.

According to one example, this electrode film can consist of a metal film, for example comprising an alkali metal (such as lithium) or an alloy comprising predominantly an alkali metal (such as lithium).

According to another example, the electrode film is a current collector, for example comprising an electron-conducting solid support, such as a metal foil or grid (such as copper, nickel, etc.), a carbon or carbon-containing film (such as carbon paper, self-supported graphene, etc.), or another solid support (polymer, glass, etc.) comprising an electron-conducting layer (such as a current collector print). This can, for example, be lithiated during the first charge and discharge cycles. This lithiation process then generally occurs on the surface of the electron-conducting solid support or inside the meshes for a grid, or inside a pretreatment layer, in either case lithiation occurs on the surface of the electron-conducting solid support in contact with the first thin layer.

In this case, surface modification means the application of a succession of two ion-conducting thin films that act as a barrier to dendrite formation, but without substantially reacting with the surface of the electrode film, the thin film elements being mainly unreactive.

The surface of the electrode film is modified by applying to one of its surfaces a first thin layer comprising an inorganic compound in a solvating polymer, optionally including an ionic salt and/or plasticizer. The first thin layer has an average thickness of about 15 μm or less. The inorganic compound is present in the first thin layer in a weight ratio of “inorganic compound:solvating polymer” in the first thin layer in the range from about 1:20 to about 20:1. The solvating polymer in the first layer may or may not be crosslinked. The second thin layer comprises a solvating polymer, an ionic salt and optionally a plasticizer, the second thin layer being disposed on the first thin layer and having an average thickness of about 15 μm or less. The solvating polymer of the first layer is the same as or different from the solvating polymer of the second layer.

The inorganic compound is preferably in particle form (e.g. spherical, rod-shaped, needle-shaped, etc.). The average particle size is preferably nanometric, for example, less than 1 μm, less than 500 nm, or less than 300 nm, or less than 200 nm, or between 1 nm and 500 nm, or between 10 nm and 500 nm, or between 50 nm and 500 nm, or between 100 nm and 500 nm, or between 1 nm and 300 nm, or between 10 nm and 300 nm, or between 50 nm and 300 nm, or between 100 nm and 300 nm, or between 1 nm and 200 nm, or between 10 nm and 200 nm, or between 50 nm and 200 nm, or between 100 nm and 200 nm, or between 1 nm and 100 nm, or between 10 nm and 100 nm, or between 25 nm and 100 nm, or between 50 nm and 100 nm.

Non-limiting examples of inorganic compounds include compounds Al₂O₃, Mg₂B₂O₅, Na₂O·2B₂O₃, xMgO·yB₂O₃·zH₂O, TiO₂, ZrO₂, ZnO, Ti₂O₃, SiO₂, Cr₂O₃, CeO₂, B₂O₃, B₂O, SrBi₄Ti₄O₁₅, LLTO, LLZO, LAGP, LATP, Fe₂O₃, BaTiO₃, γ-LiAlO₂, a metal/carbon mixture (such as Sn+C, Zn+C, Ni₂P+C), molecular sieve or zeolite (e.g., of aluminosilicate, of mesoporous silica), a sulfide ceramic (like Li₇P₃S₁₁), a glass ceramic (such as LIPON, etc.), and other ceramics, and their combinations.

The surface of the particles of inorganic compound can also be modified by organic groups covalently grafted onto their surface. For example, the groups may be selected from crosslinkable groups (such as organic groups comprising acrylate functions, methacrylate functions, vinyl functions, glycidyl functions, mercapto functions, etc.), aryl groups, alkylene oxide or poly(alkylene oxide) groups, and other organic groups, or one of their combinations, optionally including a spacer group between the organic groups and the particles of inorganic compound.

According to other examples, the crosslinkable groups may comprise silane or halogenated silane, phosphonate, carboxylate, catechol, (meth)acrylate or poly(meth)acrylate, alkylene or polyalkylene functions, and combinations thereof. Scheme 1 shows an example of a grafting method for silanes comprising propyl methacrylate groups.

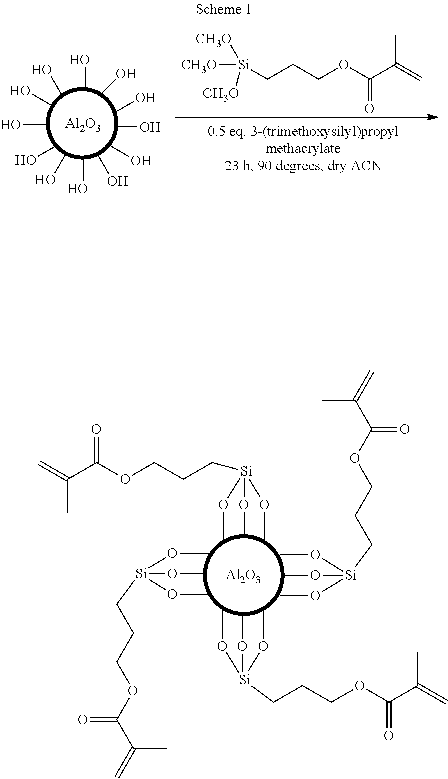

In this example, the methacrylate group present on the propylsilane function can then be reacted with compatible groups, for example, to form a polymer chain such as a polyether. An example of this type of reaction will be shown below in Scheme 3.

In some cases, the inorganic compound particles have a small specific surface area (for example, less than 80 m²/g, or less then 40 m²/g). The concentration in inorganic compound in the first thin layer may then be relatively high. For instance, the “inorganic compound:solvating polymer” weight ratio in the first thin layer may be in the range from about 2:5 to about 4:1, or from about 2:5 to about 2:1, or from about 1:2 to about 2:1, or from about 4:5 to about 2:1, or from about 1:1 to about 2:1, or from about 4:5 to about 3:2.

In other cases, the inorganic compound particles have a high specific surface area (for example, of 80 m²/g or more, or of 120 m²/g or more). The greater porosity of the inorganic compound may then require a greater amount of polymer, and the concentration of the inorganic compound in the first thin layer will be lower. For instance, the “inorganic compound:solvating polymer” weight ratio in the first thin layer may be then in the range from about 1:20 to about 2:1, or from about 2:5 to about 2:1, from about 2:5 to about 6:5, or from about 1:20 to about 6:5, or from about 2:5 to about 1:1, or from about 1:20 to about 1:1, or from about 2:5 to about 4:5, or from about 1:20 to about 4:5.

As described above, the average thickness of the first and second thin layers is such that the latter is considered a modification of the electrode surface rather than an electrolyte layer. As mentioned above, the average thickness of the first and second thin layers is less than 15 μm, respectively.

For example, for the first thin layer, the average thickness may be between about 0.5 μm and about 15 μm, or between about 1 μm and about 15 μm, or between about 1 μm and about 12 μm, or between about 0.5 μm and about 10 μm, or between about 1 μm and about 10 μm, or between about 2 μm and about 8 μm, or between about 2 μm and about 7 μm, or between 2 μm and about 5 μm.

As for the second thin layer, its average thickness may be between about 50 nm and about 15 μm, or between about 0.1 μm and about 15 μm, or between about 0.5 μm and about 15 μm, or between about 1 μm and about 15 μm, or between about 1 μm and about 12 μm, or between about 0.5 μm and about 10 μm, or between about 1 μm and about 10 μm, or between about 2 μm and about 8 μm, or between about 2 μm and about 7 μm, or between 2 μm and about 5 μm, or between about 50 nm and about 5 μm, or between about 0.1 μm and about 2 μm.

For instance, the total average thickness of the first and second thin layers may be in the range from about 1 μm to about 30 μm, or from about 1 μm to about 25 μm, or from about 5 μm to about 25 μm, or from about 1 μm to about 20 μm, or from about 1 μm to about 16 μm, or from about 2 μm to about 12 μm, or from about 3 μm to about 15 μm, or from about 3 μm to about 12 μm, or from about 4 μm to about 15 μm, or from about 4 μm to about 12 μm.

The polymer present in the first and/or second layer is independently selected from polymers comprising ion solvating units, in particular lithium ions. Examples of solvating polymers include linear or branched polyether polymers (e.g. PEO, PPO, or EO/PO copolymer), poly(dimethylsiloxanes), poly(alkylene carbonates), poly(alkylene sulfones), poly(alkylene sulfamides), polyurethanes, polyvinyl alcohols, polyacrylonitriles, poly(methyl methacrylates), and copolymers thereof, optionally comprising crosslinked units derived from crosslinkable functions (such as acrylate functions, methacrylate functions, vinyl functions, glycidyl functions, mercapto functions, etc.).

According to some examples, at least one of the first and second thin layers further comprises a plasticizer. The first thin layer and the second thin layer may each comprise a plasticizer. In some alternatives, only the first thin layer further comprises a plasticizer. The plasticizers used are those generally known to be compatible with electrochemical cells and cycling conditions. They generally include organic liquids with relatively high boiling points. Non-limiting examples of plasticizers include liquids of the type glycol diethers (such as tetraethylene glycol dimethyl ether (TEGDME)), carbonate esters (such as propylene carbonate, ethylene carbonate, fluoroethylene carbonate), lactones (such as γ-butyrolactone), adiponitrile, ionic liquids and the like.

According to a preferred example, at least one of the first and second thin layers further comprises a lithium salt, for instance, both layers may comprise a lithium salt. Non-limiting examples of lithium salts include lithium hexafluorophosphate (LiPF₆), lithium bis(trifluoromethanesulfonyl)imide (LiTFSI), lithium bis(fluorosulfonyl)imide (LiFSI), lithium 2-trifluoromethyl-4,5-dicyano-imidazolate (LiTDI), lithium 4,5-dicyano-1,2,3-triazolate (LiDCTA), lithium bis(pentafluoroethylsulfonyl)imide (LiBETI), lithium tetrafluoroborate (LiBF₄), lithium bis(oxalato)borate (LiBOB), lithium nitrate (LiNO₃), lithium chloride (LiCl), lithium bromide (LiBr), lithium fluoride (LiF), lithium perchlorate (LiClO₄), lithium hexafluoroarsenate (LiAsF₆), lithium trifluoromethanesulfonate (LiSO₃CF₃) (LiTf), lithium fluoroalkylphosphate Li[PF₃(CF₂CF₃)₃] (LiFAP), lithium tetrakis(trifluoroacetoxy)borate Li[B(OCOCF₃)₄] (LiTFAB), lithium bis(1,2-benzenediolato(2-)-O,O′)borate Li[B(C₆O₂)₂] (LBBB), or a combination of two or more thereof.

As mentioned above, the electrode film can comprise a metal film, which is preferably a film of lithium or of an alloy comprising lithium, optionally on a current collector. When the metal film is a lithium film, it is composed of lithium containing less than 1000 ppm (or less than 0.1% by weight) of impurities. Alternatively, a lithium alloy may comprise at least 75% by weight of lithium, or between 85% and 99.9% by weight of lithium. The alloy may then comprise an element selected from alkali metals other than lithium (such as Na, K, Rb, and Cs), alkaline earth metals (such as Mg, Ca, Sr, and Ba), rare earth metals (such as Sc, Y, La, Ce, Pr, Nd, Sm, Eu, Gd, Tb, Dy, Ho, Er, Tm, Yb, Lu), zirconium, copper, silver, bismuth, cobalt, manganese, zinc, aluminum, silicon, tin, antimony, cadmium, mercury, lead, molybdenum, iron, boron, indium, thallium, nickel and germanium (e.g. Zr, Cu, Ag, Bi, Co, Zn, Al, Si, Sn, Sb, Cd, Hg, Pb, Mn, B, In, TI, Ni, or Ge).

The electrode film may also further comprise a pretreatment layer on the first surface, which is in contact with the first thin layer. For example, the pretreatment layer comprises a compound selected from a silane, a phosphonate, a borate, an organic salt or compound, a carbon (such as graphite, graphene, etc.), an inorganic salt or compound (such as LiF, Li₃N, Li₃P, LiNO₃, Li₃PO₄, etc.), or a thin layer of an element different from a metal of the electrode film or forming an alloy therewith at the surface (e.g., an element as defined above with reference to alloys), said pretreatment layer having an average thickness of less than 1 μm, or less than 500 nm, or less than 200 nm, or less than 100 nm, or less than 50 nm. The pretreatment layer is generally produced by contacting the first surface of the electrode film with an organic or inorganic compound using known processes. For example, contacting a lithium film with PCl₃ generally produces Li₃P and/or Li₃PO₄. Similarly, the application of a powder or a very thin film of a metal element different from a metal of the electrode film, for example, selected from the elements defined above, can produce a thin alloy layer.

For example, the pretreatment layer is formed on the electrode film before the first thin layer is added. The surface of the electrode film can also be treated before the first thin layer is applied, for example by stamping.

In another example, the electrode comprises a current collector in contact with the second surface of the electrode film.

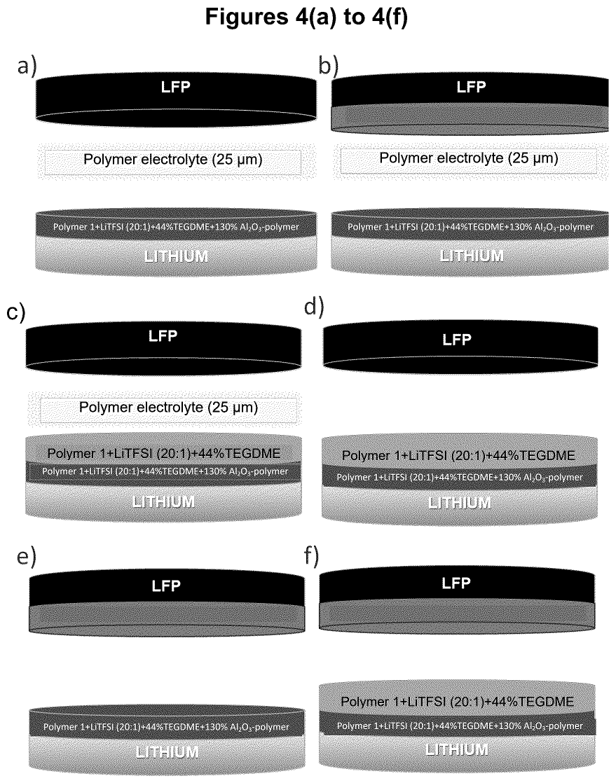

Electrochemical cells comprising the present surface-modified electrode are also contemplated. For instance, such an electrochemical cell comprises a negative electrode and a positive electrode, wherein at least one of the negative electrode and the positive electrode is as herein defined and can be illustrated, for example, in FIGS. 4(c), (d) and (f). According to a preferred example, the negative electrode is as herein defined and comprises an electrode film as defined above; and the positive electrode comprises a film of positive electrode material comprising a positive electrode electrochemically active material, optionally a binder, and optionally an electronically conductive material.

For example, the positive electrode electrochemically active material may be selected from metal phosphates, lithiated metal phosphates, metal oxides and lithiated metal oxides, but also other materials such as elemental sulfur, selenium, or iodine, iron(III) fluoride, copper(II) fluoride, lithium iodide, carbon based active materials. Examples of positive electrode electrochemically active material comprise LiM′PO₄ where M′ is Fe, Ni, Mn, Co, or a combination thereof, LiV₃O, V₂O₅F, LiV₂O₅, LiMn₂O₄, LiM″O₂, where M″ is Mn, Co, Ni, or a combination thereof (such as NMC, LiMnₓCo_{y}Ni_{z}O₂ with x+y+z=1), Li(NiM′″)O₂ (where M′″ is Mn, Co, Al, Fe, Cr, Ti, Zr, or a combination thereof), elemental sulfur, elemental selenium, elemental iodine, iron(III) fluoride, copper(II) fluoride, lithium iodide, carbon based active materials, organic cathode active materials such as polyimide, poly(2,2,6,6-tetramethylpiperidinyloxy-4-yl methacrylate) (PTMA), tetra-lithium perylene-3,4,9,10-tetracarboxylate (PTCLi₄), naphthalene-1,4,5,8-tetracarboxylic dianhydride (NTCDA), perylene-3,4,9,10-tetracarboxylic dianhydride (PTCDA), π-conjugated dicarboxylates, and anthraquinone, or a combination of two or more of these materials when they are compatible with each other and with the negative electrode, for instance, a lithium electrode. The positive electrode electrochemically active material is preferably in the form of particles, which may be optionally coated, for example, with polymer, ceramic, carbon, or a combination of two or more thereof.

Examples of electronically conductive materials that can be included in the electrode material include carbon black (such as Ketjen™, Denka™, Shawinigan, acetylene black, etc.), graphite, graphene, carbon nanotubes, carbon fibers (including carbon nanofibers, vapor grown carbon fibers (VGCF), etc.), non-powdery carbon obtained by carbonization of an organic precursor (e.g., as a coating on particles), or a combination of at least two of these.

Non-limiting examples of electrode material binders include the polymer binders described above in connection with the thin layers or below for the electrolyte, but also rubber-type binders such as SBR (styrene-butadiene rubber), NBR (acrylonitrile-butadiene rubber), HNBR (hydrogenated NBR), CHR (epichlorohydrin rubber), and ACM (acrylate rubber), or fluorinated polymer-type binders such as PVDF (polyvinylidene fluoride), PTFE (polytetrafluoroethylene), and combinations thereof. Some binders, such as rubber-type binders, may also include an additive such as CMC (carboxymethylcellulose).

Other additives may also be present in the electrode material, such as lithium salts or inorganic particles like ceramics or glass, or other compatible active materials (e.g. sulfur).

According to one example, the film of positive electrode material comprises a first and a second surfaces, the first surface facing the negative electrode and carrying a third thin layer comprising a solvating polymer (for example, as defined above), an ionic salt (for example, as defined above), the third thin layer having an average thickness of about 50 μm or less, about 40 μm or less, or about 30 μm or less, or about 15 μm or less, or about 10 μm or less, or is between about 0.5 μm and about 50 μm, or between about 5 μm and about 50 μm, or between about 5 μm and about 40 μm, or between about 0.5 μm and about 15 μm, or between about 1 μm and about 15 μm, or between about 1 μm and about 12 μm, or between about 0.5 μm and about 10 μm, or between about 1 μm and about 10 μm, or between about 2 μm and about 8 μm, or between about 2 μm and about 7 μm, or between 2 μm and about 5 μm. The third thin layer may also comprise a plasticizer, for example as defined above.

The positive electrode material can be applied to a current collector (e.g. aluminum, copper). According to one example, the current collector is carbon-coated aluminum.

According to one example, the electrochemical cell excludes the presence of a solid polymer electrolyte layer, excluding, for example, an electrolyte layer with a thickness of more than 15 μm, or 20 μm or more. It is understood that the cell also does not include any other type of electrolyte, for example, liquid or gel impregnating a separator.

Alternatively, the electrochemical cell further comprises a solid electrolyte layer comprising a polymer and a lithium salt. For example, the polymer from the electrolyte may be selected from linear or branched polyether polymers (e.g. PEO, PPO, or EO/PO copolymer), and optionally comprising crosslinkable units), poly(dimethylsiloxanes), poly(alkylene carbonates), poly(alkylene sulfones), poly(alkylene sulfamides), polyurethanes, poly(vinyl alcohols), polyacrylonitriles, poly(methyl methacrylates), and copolymers thereof, the solvating polymer being optionally crosslinked. The lithium salt can be as defined above with reference to thin layers. The solid electrolyte may further comprise a ceramic.

According to an alternative embodiment, the present document also relates to an electrochemical cell comprising a negative electrode and a positive electrode, wherein the negative electrode comprises a negative electrode film and the positive electrode comprises a positive electrode material film comprising a positive electrode electrochemically active material, optionally a binder, and optionally an electronically conductive material, and wherein:
(a) the negative electrode film comprises a first and a second surface, the first surface being optionally pretreated, wherein said negative electrode comprises a first thin layer comprising an inorganic compound in a solvating polymer and optionally an ionic salt and/or a plasticizer, the first thin layer being disposed on the first surface of the negative electrode film and having an average thickness of about 15 μm or less, the “inorganic compound:solvating polymer” weight ratio in the first thin layer is in the range of about 1:20 to about 20:1; and
(b) the negative electrode comprises a second thin layer comprising a solvating polymer, an ionic salt and optionally a plasticizer, the second thin layer being disposed on the first thin layer and having an average thickness of about 15 μm or less, wherein the solvating polymer of the first layer is the same as or different from the solvating polymer of the second layer; and/or
the positive electrode material film comprises a first and a second surface, the first surface facing the negative electrode and carrying a third thin layer comprising a solvating polymer and an ionic salt, the third thin layer having an average thickness of about 50 μm or less, or of about 15 μm or less;
   wherein the electrochemical cell excludes the presence of an additional solid polymer electrolyte layer. The electrochemical cell also excludes any other type of additional electrolyte, thereby ruling out the use of liquid or gel-type electrolytes, for example, impregnated into a separator. Examples of such a cell are illustrated in FIGS. 4(d), (e) and (f).

According to one example, the electrochemical cell comprises the second thin layer. In another example, the electrochemical cell comprises the third thin layer. In yet another example, the electrochemical cell comprises the second and third thin layers.

The solvating polymer of each of the thin layers is independently as defined herein and may be independently crosslinked or non-crosslinked. According to one example, the solvating polymer of at least one of the first, second and third layers is non-crosslinked. According to one example, the solvating polymer of the first layer is non-crosslinked. According to another example, the solvating polymer of the second layer is non-crosslinked. The solvating polymer in each of the first, second and third layers may be non-crosslinked. Or the polymer in the third layer is crosslinked and that in the first and second layers is non-crosslinked. Alternatively, the solvating polymer in each of the first, second and third layers may be crosslinked.

As with the above electrode film, the negative electrode film of the present electrochemical cell can be a current collector, for example comprising an electron-conducting solid support, such as a metal foil or grid (such as copper, nickel, etc.), a carbon or carbon-containing film (such as carbon paper, self-supported graphene, etc.), or other solid support (polymer, glass, etc.) comprising an electron-conducting layer (such as a current collector print). Alternatively, the negative electrode film may comprise a metal film, for example comprising lithium or an alloy comprising lithium, the film of lithium and alloys thereof may also be defined as above. The present negative electrode film may also comprise a pretreatment layer as mentioned above.

The inorganic material of the first thin layer is as defined above and can be included in the same weight ratios described above.

The average thickness of the first thin layer can be between about 0.5 μm and about 15 μm, or between about 1 μm and about 15 μm, or between about 1 μm and about 12 μm, or between about 0.5 μm and about 10 μm, or between about 1 μm and about 10 μm, or between about 2 μm and about 8 μm, or between about 2 μm and about 7 μm, or between 2 μm and about 5 μm.

The average thickness of the second thin layer may be between about 50 nm and about 15 μm, or between about 0.1 μm and about 15 μm, between about 0.5 μm and about 15 μm, or between about 1 μm and about 15 μm, or between about 1 μm and about 12 μm, or between about 0.5 μm and about 10 μm, or between about 1 μm and about 10 μm, or between about 2 μm and about 8 μm, or between about 2 μm and about 7 μm, or between about 2 μm and about 5 μm, or between about 50 nm and about 5 μm, or between about 0.1 μm and about 2 μm.

In fact, when the second thin layer is present, the total average thickness of the first and second thin layers is preferably in the range from about 1 μm to about 30 μm, or from about 1 μm to about 25 μm, or from about 5 μm to about 25 μm, or from about 1 μm to about 20 μm, or from about 1 μm to about 16 μm, or from about 2 μm to about 12 μm, or from about 3 μm to about 15 μm, or from about 3 μm to about 12 μm, or from about 4 μm to about 15 μm, or from about 4 μm to about 12 μm.

The average thickness of the third thin layer is about 40 μm or less, or about 30 μm or less, or about 15 μm or less, or between about 0.5 μm and about 50 μm, or between about 5 μm and about 50 μm, or between about 5 μm and about 40 μm, or between about 0.5 μm and about 15 μm, or between about 1 μm and about 15 μm, or between about 1 μm and about 12 μm, or between about 0.5 μm and about 10 μm, or between about 1 μm and about 10 μm, or between about 2 μm and about 8 μm, or between about 2 μm and about 7 μm, or between 2 μm and about 5 μm.

It may be noted that when only one of the second and third thin layers is present, the layer present may have a slightly greater thickness. When the second thin layer and the third thin layer are both present, these will be thinner, and the total average thickness of the first, second and third thin layers may be in the range from about 3 μm to about 60 μm, or from about 10 μm to about 50 μm, or from about 15 μm to about 30 μm, or from about 3 μm to about 30 μm, or from about 3 μm to about 25 μm, or from about 5 μm to about 25 μm, or from about 5 μm to about 20 μm, or from about 8 μm to about 15 μm, or from about 8 μm to about 12 μm, or from about 5 μm to about 15 μm, or from about 5 μm to about 12 μm, or from about 5 μm to about 15 μm, or from about 9 μm to about 15 μm.

According to some examples, at least one of the first and second thin layers further comprises a plasticizer, preferably the first thin layer and the second thin layer further comprise a plasticizer. The third thin layer may also further comprise a plasticizer. The plasticizer is also as defined above. Similarly, at least one of the first, second and third thin layers may further comprise a lithium salt, preferably each of the three layers. The lithium salt is also as defined above.

The negative electrode may also further comprise a current collector in contact with the second surface of the negative electrode film. Similarly, the positive electrode may also further comprise a current collector in contact with the second surface of the positive electrode material film. The positive electrode material is also as defined with reference to the preceding electrochemical cell.

The present document relates to an electrochemical accumulator comprising at least one electrochemical cell as defined herein. For example, the electrochemical accumulator is a lithium or lithium-ion battery.

According to another aspect, the electrochemical accumulators of the present application are intended for use in mobile devices, for example cell phones, cameras, tablets or laptops, in electric or hybrid vehicles, or in renewable energy storage.

The present document also relates to a process for the preparation of a surface-modified electrode as described herein. This process comprises (i) mixing an inorganic compound and a solvating polymer in a solvent, optionally comprising a salt and/or a plasticizer; (ii) spreading the mixture obtained in (i) over the electrode surface; (iii) removing the solvent to obtain a first thin layer; (iv) mixing a solvating polymer and a salt in a solvent, optionally comprising a plasticizer; (v) spreading the mixture obtained in (iv) over the first thin layer obtained in (iii); and (vi) removing the solvent.

When steps (i) and/or (iv) further comprise a crosslinking agent, the process may further comprise a polymer crosslinking step (e.g. ionically, thermally or by irradiation), before, after or during steps (iii) and/or (vi), respectively.

When the electrode is a metal film such as lithium, steps (ii), (iii), (v) and/or (vi) are preferably carried out under vacuum, or in an anhydrous chamber that can be filled with an inert gas such as argon.

Alternatively, when the polymer is crosslinkable and sufficiently liquid prior to crosslinking, the process can exclude the presence of solvent and steps (iii) and/or (vi) can be avoided.

The mixing steps can be carried out by various methods used in the field of the present technology. For example, such methods may include planetary mixers, ball mixers, disk mixers, ultrasonic mixers (e.g., sonotrode mixers), homogenizers (such as a rotor-stator homogenizer), etc.

Spreading can be carried out by conventional methods, e.g. using a roller, such as a rolling mill roller, coated with the mixture (including a continuous roll-to-roll treatment method), doctor blade, spray coating, centrifuging, printing, etc.

The organic solvent used can be any solvent non-reactive with the electrode film, for example, non-reactive with lithium when the electrode film comprises lithium metal. Examples include tetrahydrofuran (THF), dimethylsulfoxide (DMSO), heptane, toluene or a combination thereof.

### EXAMPLES

The following non-limiting examples are illustrative embodiments and should not be construed as further limiting the scope of the present invention. These examples will be better understood by reference to the appended figures.

Unless otherwise specified, numbers expressing component quantities, preparatory conditions, concentrations, properties, etc. used herein are to be interpreted as modified at each instance by the term “about”. At the very least, each numerical parameter should be interpreted in the light of the number of significant figures reported, and by the application of usual rounding techniques. Therefore, unless otherwise indicated, the numerical parameters mentioned here are approximations that may vary depending on the properties sought. Nevertheless, although the parameters defining the broadest realizations are approximations, the numerical values presented in the following examples are reported as precisely as possible. Any numerical value, however, inherently contains a certain margin of error resulting from variations in experiments, measurements, statistical analyses, etc.

### Example 1—Synthesis and Characterization of Ceramics

### (a) Synthesis of Ni₂P and Characterization

The Ni₂P nanoparticles are synthesized by a liquid route using a vacuum ramp («Schlenk line»), but could also be synthesized by other known means, for example, under pressurized solvothermal conditions using an autoclave.

0.9962 g of Ni(acac)₂ and 20 mL of 1-octadecene are added to a 250 mL three-neck flask with a magnetic stirring bar. The mixture is gently stirred (500 RPM) and the temperature of the mixture is raised to 120° C. The reaction mixture is then stirred at this temperature under vacuum for 30 minutes to remove volatile impurities and traces of water. The system is then purged with argon and bubbled for at least 5 minutes in the liquid. Next, 8 mL of tri-n-octylphosphine are introduced through a septum using a syringe. The mixture is then heated to 320° C. and left to react for 20 hours.

The mixture is then allowed to slowly cool to room temperature and centrifuged at 10,000 RPM for 30 minutes in small 25 mL centrifuge tubes. The powder is easier to recover owing to the absence of surfactant. The light-brown supernatant is removed, the powder is redispersed in ethanol and the black liquid obtained is centrifuged again. This step is repeated three more times. A black powder is obtained in nearly 90% yield.

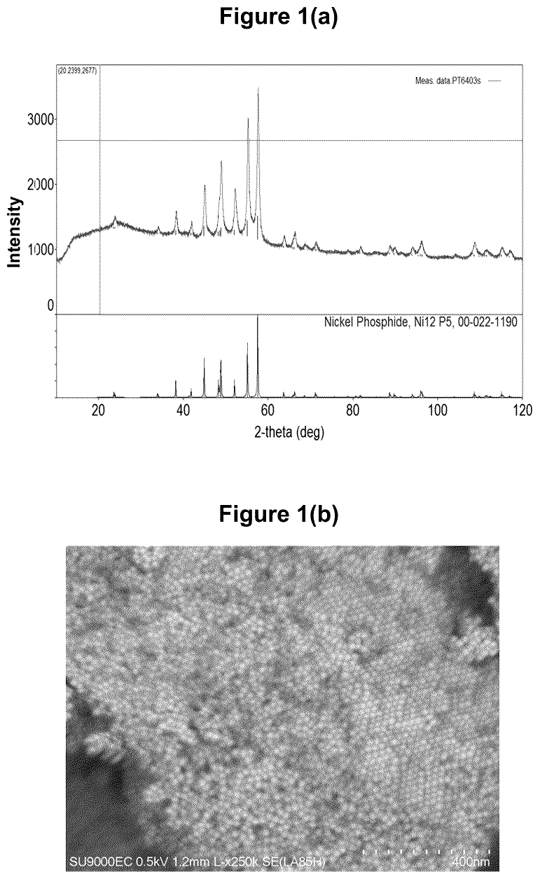

FIG. 1(a) shows the X-ray diffractogram of the obtained material's powder. The peaks obtained are relatively broad and not very intense, confirming the nanometric size of the Ni₂P particles. There is only one phase obtained, which is in fact a Ni₁₂P₅ phase. FIG. 1(b) shows a scanning microscope image of the Ni₁₂P₅ powder. A single phase is clearly visible, composed of small spherical particles having a diameter of around 20 nm.

### (b) Synthesis of Modified Al₂O₃ (Al₂O₃-Polymer) and Characterization

Attachment of a polymer to a ceramic surface is done in two steps. For the demonstration, Al₂O₃ powder (needle-like, ˜164 m²/g) was used. First, a silanization reaction is carried out on the surface of the Al₂O₃ particles to attach crosslinkable groups. Scheme 2 shows this first surface modification step.

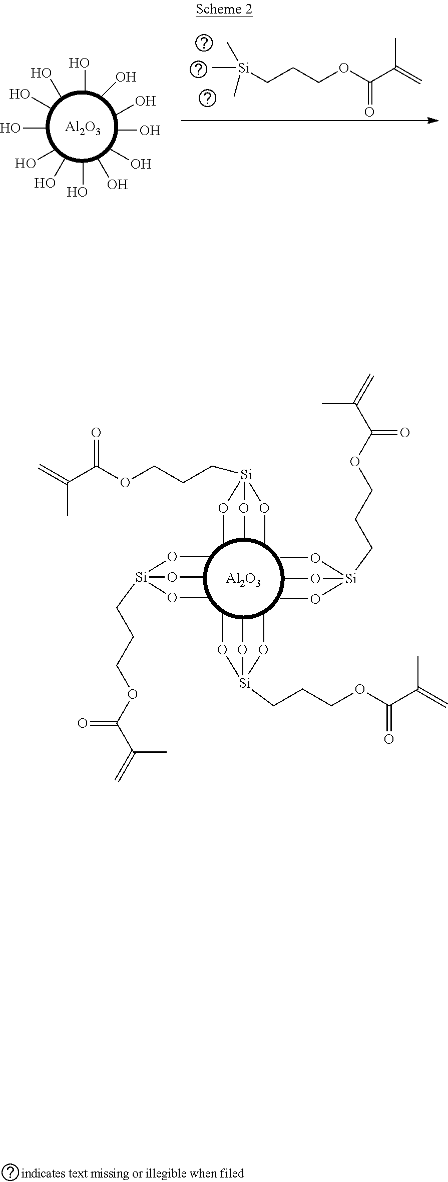

About 10 g of the Al₂O₃ powder are dispersed using an ultrasonic rod in 100 mL of toluene. The mixture is poured into a 250 mL glass round-bottom flask fitted with an air condenser. The mixture is kept under stirring and the system is purged with nitrogen for 10 min. Next, about 1 g of 3-(trimethoxysilyl)propyl methacrylate is added, and the liquid is maintained at 90° C. for 17 hours. Once the liquid has returned to room temperature, it is centrifuged using a 250 mL centrifuge tube (5000 RPM, 20 minutes). The powder obtained is cleaned 3 times with acetone by centrifugation, then dried at 140° C. under vacuum for at least 24 hours.

The second step consists in polymerizing polyethylene glycol units on the surface of the Al₂O₃ particles. Scheme 3 shows the reaction protocol.

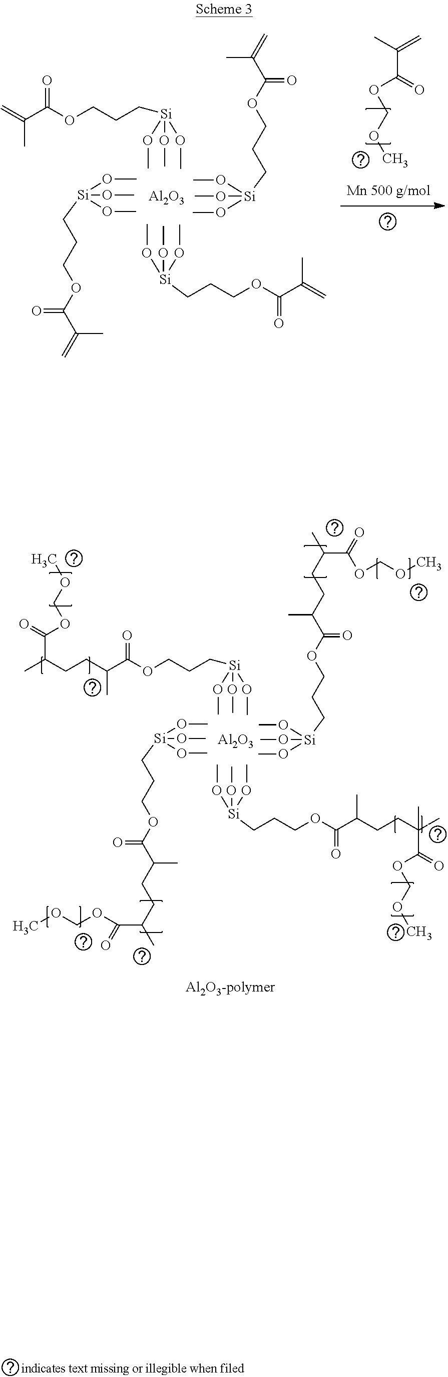

The modified powder prepared previously is dispersed again in toluene using the same dispersion method. Nitrogen is bubbled into the liquid to remove traces of oxygen. Polyethylene glycol methacrylate (Mn=500 g/mol) is added in a proportion of 15% by weight relative to alumina, followed by 0.5% by weight of azobisisobutyronitrile (AIBN).

The assembly is equipped with an air condenser, and a flow of nitrogen is maintained throughout the reaction. The temperature is set at 80° C. for 17 hours. Once the liquid has returned to room temperature, it is centrifuged using a 250 mL centrifuge tube (5000 RPM, 20 minutes). The powder obtained is cleaned 3 times with acetone by centrifugation, then dried at 120° C. under vacuum for at least 24 hours. This powder is referred to as Al₂O₃-polymer.

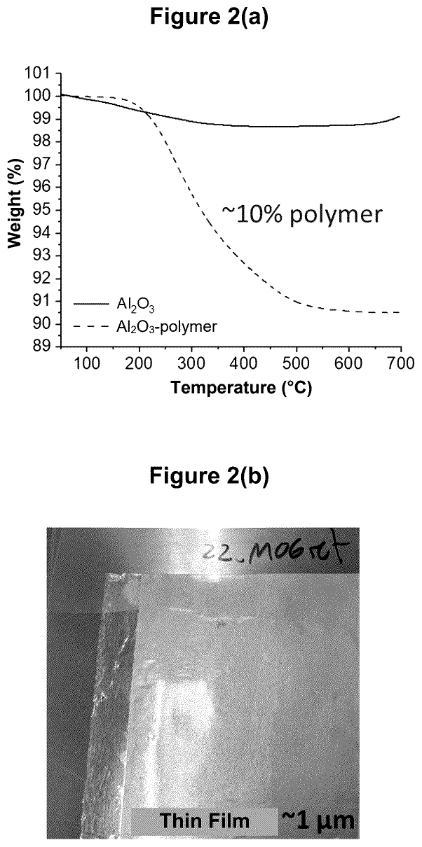

FIG. 2(a) shows the thermogravimetric curves for Al₂O₃ (-) and Al₂O₃-polymer ( - - - ) powders. The continuous mass loss between 20° and 600° C. for the modified powder means that there is around 10% polymer in the final composite. FIG. 2(b) shows an example of a coating (1 μm thin layer) made on a lithium strip with an ink composed of Polymer 1+Al₂O₃-polymer. Polymer 1 refers to a polymer detailed in American U.S. Pat. No. 6,903,174 comprising crosslinkable groups.

### Example 2—Formulation of Inks for Electrode Surface Modification

(a) Polymer Inks (without Inorganic Compound)
i. Polymer Inks A1-A5 (without Inorganic Compound) and Conductivity Tests

To increase the ionic conductivity of lithium deposits, a plasticizer, tetraethylene glycol dimethyl ether (TEGDME), is used. Inks were prepared according to the proportions shown in Table 1 by mixing Polymer 1 with a lithium salt (LiTFSI), at a molar ratio of O:Li=20:1, and with different amounts of TEGDME (ranging from 8 to 40% by weight of Polymer 1). A crosslinking agent, Irgacure-651™, was also added at 0.5% by weight based on the weight of Polymer 1.

The applications were carried out by doctor blade on 50 μm thick stainless-steel strips on a coating table. The strips were left in a fume hood for 5 minutes before being inserted into a box under nitrogen flow, equipped with an ultraviolet (UV) lamp. After a 5-minute nitrogen purge, the films are crosslinked under UV light for 2 minutes.

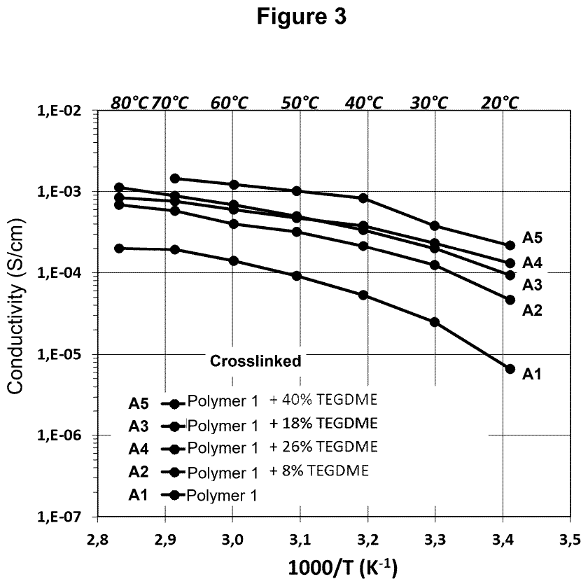

These films are then assembled into a button-type cell and conductivity measurements are taken at various temperatures between 2° and 80° C. FIG. 3 shows the conductivity measurements recorded at different temperatures for the various films A1 to A5 above deposited on stainless steel. Compared film A1 with polymer 1 and without TEGDME, almost an order of magnitude higher conductivity is obtained after the addition of only 8% TEGDME. At 50° C., a very good ionic conductivity of 1.02×10³ S/cm is obtained for the film A5 with 40% TEGDME. The mechanical strength of the film is also very good, despite the presence of 40% liquid (TEGDME).

ii. Polymer Ink A6 (for Cathode Coating)

In a plastic container compatible with a Thinky-type planetary mixer, a suitable quantity of Polymer 1 is introduced with a quantity of LiTFSI salt adjusted to obtain an O:Li molar ratio of 20:1. An anhydrous solvent, tetrahydrofuran (THF), is added in sufficient quantity to give, after mixing, an 18.5% solid solution (polymer+salt). The solution is mixed in the planetary mixer at 2000 RPM for 3 minutes. This mixing step is repeated seven times.

iii. Polymer Ink A7 (for Cathode Coating)

In a plastic container compatible with a Thinky-type planetary mixer, a suitable quantity of Polymer 1 is introduced with a quantity of LiTFSI salt adjusted to obtain an O:Li molar ratio of 25:1. An amount of plasticizer (TEGDME) equivalent to 40% of the polymer weight is added. A second anhydrous solvent, tetrahydrofuran (THF), is added in sufficient quantity to obtain, after mixing, a 21% solid (polymer+salt+TEGDME) solution. In this calculation, TEGDME is included in the solids. Finally, 0.5% by weight of Irgacure™ with respect to the polymer is added as a cross-linking agent. The solution is mixed 3 times in the planetary mixer at 2000 RPM for 10 minutes.

iv. Polymer Ink A8 with Plasticizer (for Second Layer Coating)

For coatings on lithium, a slightly higher concentration of TEGDME of 44% was chosen for polymer-inorganic compound films and polymer films, to promote mixing of ceramic particles, adhesion and good conductivity of the deposited layers.

For the second lithium coating, which does not contain ceramics, the polymer solution is prepared as follows. In a plastic container compatible with a Thinky-type planetary mixer, a suitable quantity of Polymer 1 is introduced with a quantity of LiTFSI salt so as to obtain an O:Li molar ratio of 20:1. Next, 44% by weight of TEGDME relative to the polymer is added, and everything is mixed in the planetary mixer at 2000 RPM for three minutes. THF is added in an amount sufficient to give a solution with 18.1% solid (polymer+salt) after mixing. The solution is mixed in the planetary mixer at 2000 RPM for 3 minutes. This mixing step is repeated six times.

v. Polymer Ink A9 (for Second Layer Spray Application)

A precise amount of Polymer 2 is added to a glass bottle. Polymer 2 refers to a polymer detailed in the American U.S. Pat. No. 6,903,174 but not containing crosslinkable groups. A quantity of LiTFSI salt is added to give an O:Li molar ratio of 20:1. THF solvent is added in order to obtain a very dilute solution of salted polymer. Typically, a solution comprising 4% solids is obtained (salt+polymer). The solution is rapidly homogenized simply by mixing by hand.

TABLE 1
Composition polymer inks and films

| | | | | |
|---|---|---|---|---|
| Ink/Film | Polymer | Plasticizer | Lithium salt | Crosslinker |
| (% solids) | (%)^{a} | (%)^{a} | (O:Li mol ratio) | (%)^{a} |

^{a}Percentages are by weight with respect to the weight of Polymer 1.

### (b) Polymer-Inorganic Compound Inks B₁-85 (for Anode Coating)

i. Procedure 1 (B₁-B₃ with Al₂O₃-Polymer Ceramic)

In a plastic container compatible with a Thinky-type planetary mixer, a suitable quantity of Polymer 1 is introduced with a quantity of LiTFSI salt adjusted to obtain an O:Li molar ratio of 20:1. Next, 44% by weight of TEGDME relative to the polymer is added, and everything is mixed in the planetary mixer at 2000 RPM for three minutes. After standing for 2 min, a quantity of Al₂O₃-polymer ceramic corresponding to a ratio of 56% to 130% of the polymer weight is added and everything is mixed again for 3 minutes at 2000 RPM. This mixing step is repeated four times. The resulting ink, homogeneous and free from agglomerates, is diluted with anhydrous THF to obtain a solution with 17% solid (polymer+salt+ceramic). The solution is mixed twice for 3 minutes at 2000 RPM.

The compositions (excluding solvent) of inks B1 to B3 are described in Table 2. In some experiments, Irgacure™ (0.5% by weight with respect to the polymer) was also added as a crosslinking agent. These compositions can then be designated B1(i) to B3(i), where (i) indicates the additional presence of Irgacure™.

ii. Procedure 2 (B4 with Metal/Carbon Mixture):

Further tests were carried out with nanometric Sn or Zn metal particles, as well as with a metal phosphide Ni₂P. A carbon black with spherical particles around 75 nm in diameter and a specific surface area of around 45 m²/g was used. In a plastic container, a suitable amount of Polymer 1 is introduced with a sufficient amount of LiTFSI salt to obtain an O:Li molar ratio of 20:1. Next, 44% by weight of TEGDME with respect to the polymer is added, and everything is mixed using a disk mixer (Ultra-Turrax® type) at 1000 RPM for 2 minutes until a uniform liquid is obtained. Then, a quantity of Sn, Zn or Ni₂P (of Ni₁₂P₅ phase prepared according to Example 1(a)) of between 30 and 90% by weight with respect to the polymer is introduced into the plastic container. Next, 10% to 20% by weight of carbon is added. The whole content is mixed with a disk mixer at 2500 RPM for 8 minutes. THF is added in sufficient quantity to obtain, after mixing, a solution with 17% solid (polymer+salt+carbon+metal). Finally, after introducing the THF, the solution is mixed one last time with the disk mixer at 2500 RPM for 2 minutes.

Ink B₄ shown in Table 2 is an example of an ink comprising a mixture of Ni₂P and carbon.

iii. Procedure 3 (B5-a and B5-b with Al₂O₃):

In a plastic container, a quantity of unmodified alumina (type AKPG15 non-sieved) is mixed with THF using a sonotrode (50% power) for 4 minutes (Ink E5-a) or an IKA type rotor-stator homogenizer at maximum power for 10 min (Ink E5-b). Meanwhile, a polymer solution is prepared. It contains a quantity of Polymer 1 equivalent in weight to that of alumina, and the LiTFSI salt is added to give an O:Li molar ratio of 20:1. A mass of plasticizer (TEGDME) equivalent to 100% of the polymer weight is added, without the addition of a cross-linking agent. The polymer solution is mixed in the planetary mixer at 2000 RPM for 3 times 10 minutes. Finally, the solution is poured into the plastic container containing the ceramic and THF solvent. The final solution contains around 21% solids (polymer+salt+ceramic+TEGDME). This is vortexed one last time in a conical tube before coating on the lithium.

TABLE 2
Composition of polymer inks and films

| | | | | | |
|---|---|---|---|---|---|
| Ink/Film | Inorganic | Carbon | Polymer | Plasticizer | Li salt |
| | Compound | (%) | (%)^{a} | (%)^{a} | (O:Li mol |
| | (%)^{a} | | | | ratio) |

^{a}Percentages are by weight with respect to the weight of Polymer 1.
b. Variation between B5-a and B5-b in the mixing method (see Example 2(b)(iii))

### Example 3—Surface-Modified Electrodes and Electrochemical Properties

Examples of studied cell configurations (according to the invention and as comparatives) are shown in FIGS. 4(a) to 4(f). The cells in 4(a) to 4(c) are with polymer electrolyte, while the cells in FIGS. 4(d) to 4(f) are without polymer electrolyte. All lithiums used contain at least a first thin layer of inorganic compound in a polymer (shown as Polymer 1+Al₂O₃-polymer). The cells in FIGS. 4(c), 4(d) and 4(f) comprise a second, ceramic-free layer of Polymer 1 applied to the surface of the first layer. The cells in FIGS. 4(b), 4(e) and 4(f) include a layer of Polymer 1 with a lithium salt, but without ceramics or plasticizers on the cathode surface.

(a) Modified Electrodes (One Layer with Crosslinking) (FIG. 4(a)-Type Cell)

Coin cells were assembled with an LFP cathode (8 mg/cm², composition:carbon-coated LFP:carbon black:Polymer 1:LiTFSI in proportions of about 73:1:19:7), lithiums with a layer of Polymer 1+Al₂O₃-polymer and a self-supported electrolyte film based on branched polyethylene oxide with allyl ether-type functions (25 μm thick) (hereinafter referred to as SPE). Polymer 1+Al₂O₃-polymer inks B₁(i), B₂(i) and B₃(i) were prepared (see Example 2(b) and Table 2). Note that for this example, the films deposited on lithium were crosslinked (with 0.5% by weight Irgacure™).

Coatings with these inks were carried out on the lithium surface using a doctor blade on a coating table at a speed of 10 mm/s. The lithiums were left for 5 minutes in a fume hood, followed by 5 minutes in an oven at 50° C. to evaporate the remaining THF. The films are then placed in a box under nitrogen flow equipped with a UV lamp. After a 5-minute nitrogen purge, the films are crosslinked under UV light for 2 minutes. Deposit thicknesses are around 4 μm after drying and crosslinking.

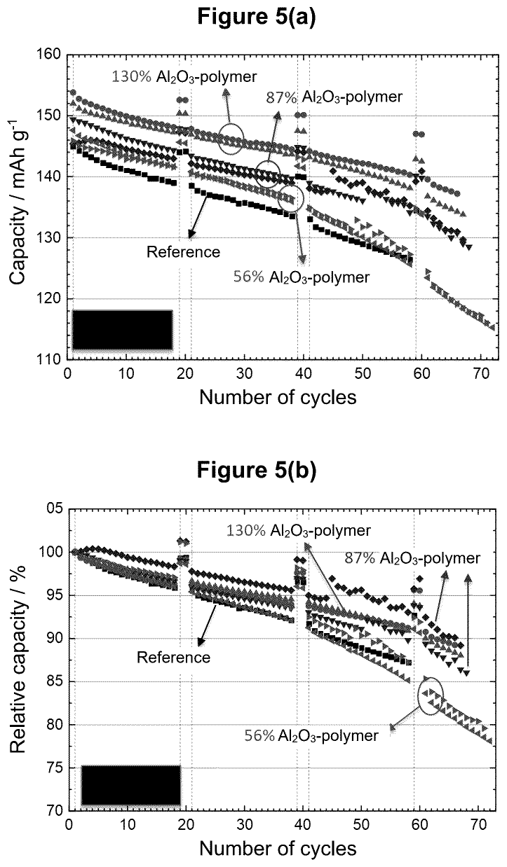

The typical assembly is as illustrated in FIG. 4(a) (varying the Al₂O₃-polymer contents according to those of inks B1(i) to B3(i)). Assemblies are thus made with three lithiums coated with a layer having different polymer-modified ceramic contents. FIG. 5(a) shows the galvanostatic cycling performed at C/6 at 50° C. for the different batteries and for the reference (LFP cathode and lithium anode without modification and self-supported polymer electrolyte). FIG. 5(b) shows the drop in capacity during cycling for the same batteries. Two batteries are cycled per lithium and the cyclings are relatively reproducible. Compared with the cycling for the reference battery, those for batteries with the polymer+ceramic layer give higher discharge capacities. The greater the amount of ceramic, the higher the capacity and the more stable the cycling.

(b) Modified Electrodes (One Layer without Crosslinking) (FIG. 4(a)-Type Cell)

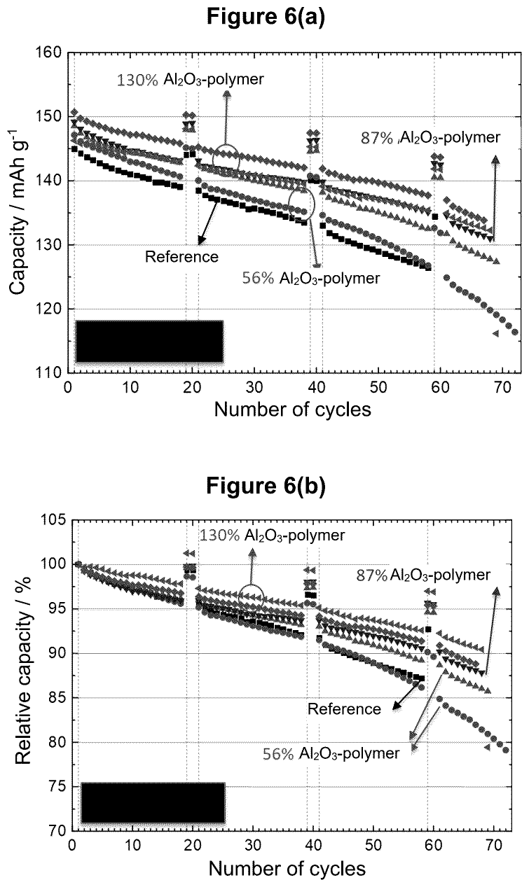

The same deposits as before (those in Example 3(a) above) without the addition of crosslinking agent (inks B1, B2 and B3) were carried out on lithium, but this time without crosslinking. In terms of electrochemical performance (see FIG. 6), the conclusions are similar. The more ceramic the polymer layer composition contains, the higher the discharge capacity (FIG. 6(a)) and the more stable the cycling (FIG. 6(b)) as the cycles progress. Thus, for the following examples of coating on lithium, the percentage of ceramic was set at 130%. Also, the polymer layer in the following examples is not cross-linked. Above 130%, with this ceramic, the layer begins to lose mechanical properties, as it approaches a “polymer in ceramic” type layer. Coating tests involving double deposition of polymer layers on lithium were therefore also carried out.

(c) Modified Electrodes (One Layer without Crosslinking) (FIG. 4(a)-Type Cell)

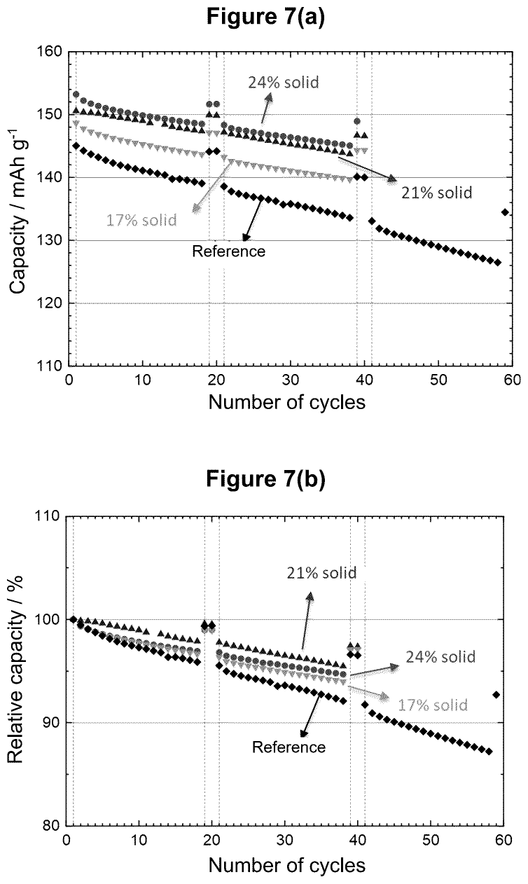

Further coating tests were carried out keeping the Al₂O₃-polymer content fixed at 130% (ink B3 according to Example 3(b)) and varying the percentage of solids in the inks between 17 and 24% depending on the amount of THF solvent added to the ink. The corresponding galvanostatic cyclings obtained at 50° C. and C/6 are shown in FIG. 7(a) and the cycling stability is shown in FIG. 7(b). It would appear that the higher the percentage of solid, the better the discharge capacity. There is very little difference between 21 and 24% solid. Capacity loss (FIG. 7(b)) is very similar for each of the modified lithiums, and capacity retention is slightly better with 21% solid in the ink composition. However, to enable a better dispersion of the ceramics in the ink, it is preferable to use solid contents of around 17%. For the following examples (first layer on lithium with various fillers such as modified Al₂O₃, Sn+carbon, Zn+carbon), the solid contents with the different ceramics are therefore set at around 17%.

(d) Typical Cells from FIGS. 4(a) to 4(f) and Comparative Cycling (in C/3)

Cells corresponding to the representations in FIGS. 4(a) to 4(f) were prepared with the elements described in Table 3.

TABLE 3
Composition of the cells (elements in order)^{a}

| | | | | Polymer | | |
|---|---|---|---|---|---|---|
| | | Composite | Polymer | electro- | Polymer | Cath- |
| Cell | Anode | layer | layer | lyte | layer | ode^{b} |
| C1 | Lithium | B3 (4 μm) | — | SPE | — | LFP |
| | | | | (25 μm) | | |
| C2-a | Lithium | B3 (4 μm) | — | SPE | A6 (2 μm) | LFP |
| | | | | (25 μm) | | |
| C2-b | Lithium | B3 (4 μm) | — | SPE | A6 (4 μm) | LFP |
| | | | | (25 μm) | | |
| C3 | Lithium | B3 (4 μm) | A8 (4 μm) | SPE | — | LFP |
| | | | | (25 μm) | | |
| C4-a | Lithium | B3 (4 μm) | A8 (9 μm) | — | — | LFP |
| C4-b | Lithium | B3 (4 μm) | A8 (12 μm) | — | — | LFP |
| C5-a | Lithium | B3 (4 μm) | — | — | A6 (5 μm) | LFP |
| C5-b | Lithium | B3 (4 μm) | — | — | A6 (8 μm) | LFP |
| C5-c | Lithium | B3 (4 μm) | — | — | A6 (11 μm) | LFP |
| C6-a | Lithium | B3 (4 μm) | A8 (3 μm) | — | A6 (4 μm) | LFP |
| C6-b | Lithium | B3 (4 μm) | A8 (4 μm) | — | A6 (4 μm) | LFP |

^{a}«—» indicates absence of the element, layers A6, A8 and B3 are defined in Example 2.
^{b}Composition of the LFP cathode defined in Example 3(a).

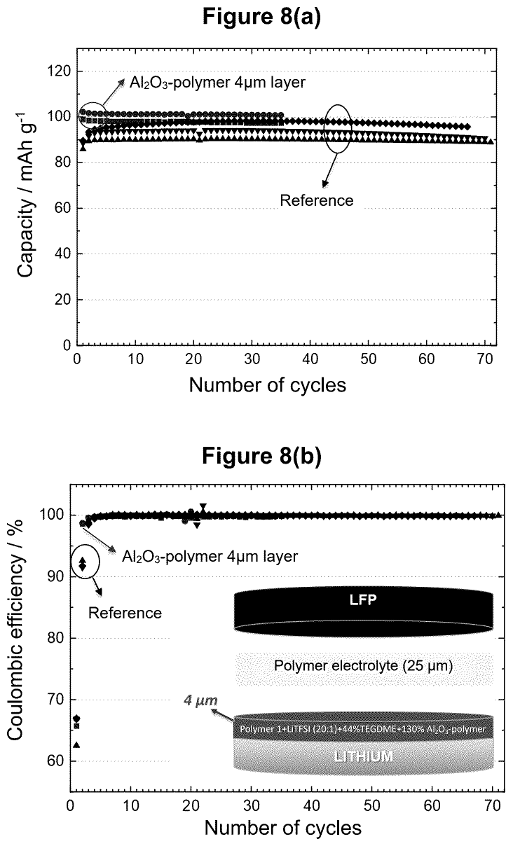

FIG. 8 shows (a) galvanostatic cycling and (b) coulombic efficiencies obtained at 50° C. and C/3 for LFP/polymer electrolyte/Li batteries assembled with unmodified lithium (reference) and lithium having a 4 μm layer of Polymer 1 with 130% Al₂O₃-polymer (cell C1). The polymer films are not crosslinked. Compared with the three reference cells, the two C1 cells with modified lithium have better reproducibility and do not show a progressive capacity gain over the first two cycles. Specific discharge capacity is also slightly higher for the cells with modified lithium. Furthermore, better coulombic efficiency (˜99%) is obtained from the second cycle for cells assembled with lithium containing the ceramic layer, whereas around 91-92% coulombic efficiency is obtained for reference cells.

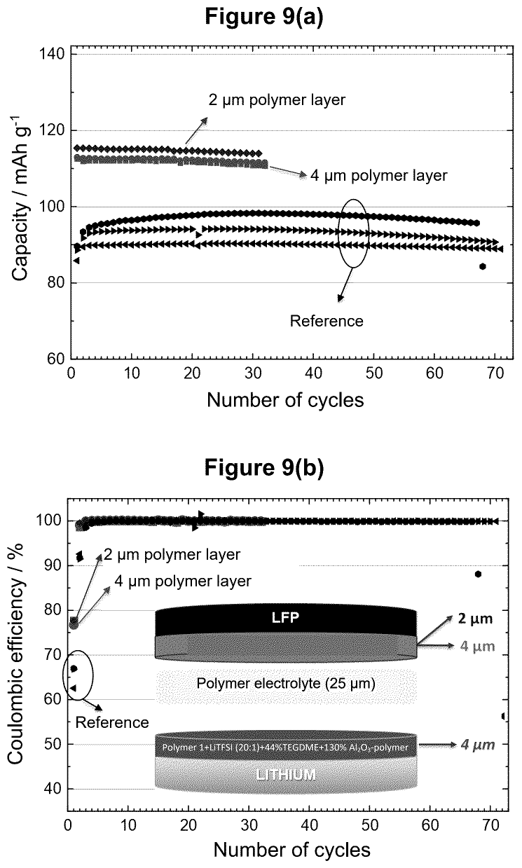

FIG. 9 shows (a) galvanostatic cycling and (b) coulombic efficiencies obtained at 50° C. and C/3 for LFP/polymer electrolyte/Li batteries assembled with lithium and the unmodified LFP cathode (reference), then with lithium having a 4 μm layer of Polymer 1 with 130% Al₂O₃-polymer and an LFP cathode having a 2 or 4 μm polymer layer (C2-a and C2-b cells, respectively). The polymer films are not crosslinked. The configuration for the lithium-modified cell assembly is shown as an inset in FIG. 9(b). Compared with the C1 cell assembly, an LFP cathode with a thin polymer layer has been used for the cells of FIG. 9 (except for the references). Overall cell resistance was reduced by the addition of this polymer layer on the LFP cathode, since discharge capacities of around 112 and 115 mAh/g were achieved when 4 and 2 μm layers were deposited on the cathode surface, respectively. Without this layer added on the cathode, discharge capacities were around 100 mAh/g (see FIG. 8(a)). Once again, reproducibility is very good using polymer layers on both lithium and cathode, as shown by the two cells cycled with the cathode having a 4 μm polymer layer. Coulombic efficiencies are also better for cells with modified cathodes and anodes. A coulombic efficiency of around 77% is obtained in the first cycle when cathodes modified with a 2 or 4 μm polymer layer are used, compared with only 62 to 66% for reference cells. This experiment demonstrates that the thin polymer layers on the surface of the electrodes (anode and cathode) enable better bonding with the self-supported polymer electrolyte, thus reducing interface resistances.

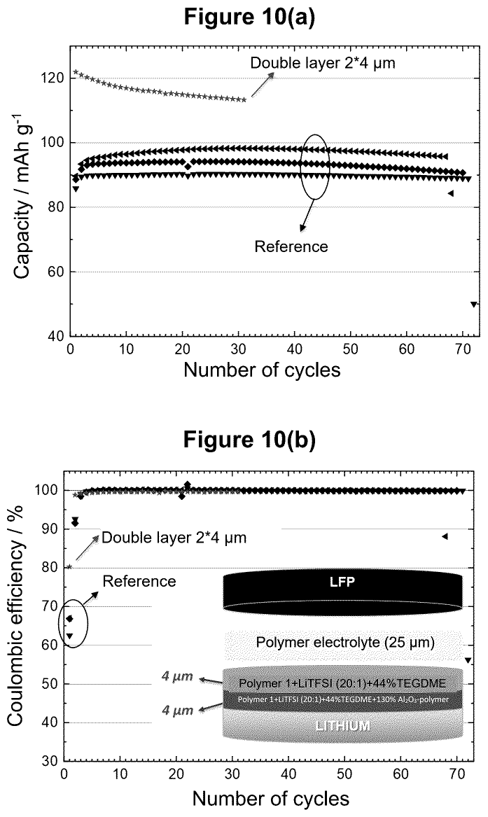

As mentioned above, the amount of ceramic in the polymer layer deposited on the lithium surface has been set at 130%, as beyond this the layer loses not only in mechanicity, but also in adhesion. A second adhesive layer, not containing ceramic, but only the polymer, salt, and TEGDME, is therefore deposited on the surface of the first Polymer 1+Al₂O₃-polymer layer to reduce the interfacial resistance between the anode and polymer electrolyte. The polymer films are not crosslinked. FIG. 10 shows (a) galvanostatic cycling and (b) coulombic efficiencies obtained at 50° C. and C/3 for LFP/polymer electrolyte/Li batteries assembled with unmodified lithium (reference), then with lithium having a first 4 μm layer of Polymer 1 with 130% Al₂O₃-polymer and a second 4 μm layer of Polymer 1 (cell C3). The inset image (FIG. 10(b)) provides a better view of the two layers deposited on the lithium surface. The improvement in the interface between the self-supported polymer electrolyte and the anode is clearly visible, since an initial discharge capacity of 121 mAh/g was achieved, whereas around 100 mAh/g was obtained with C1 cells when only the Al₂O₃-polymer layer was deposited on lithium (see cycling in FIG. 8(a)). However, a progressive capacity loss was observed. It is possible that the layer is not optimal in this case. Coulombic efficiency reaches 80% in the first cycle for the C3 cell cycled with lithium containing both polymer layers (62 to 66% for reference cells).

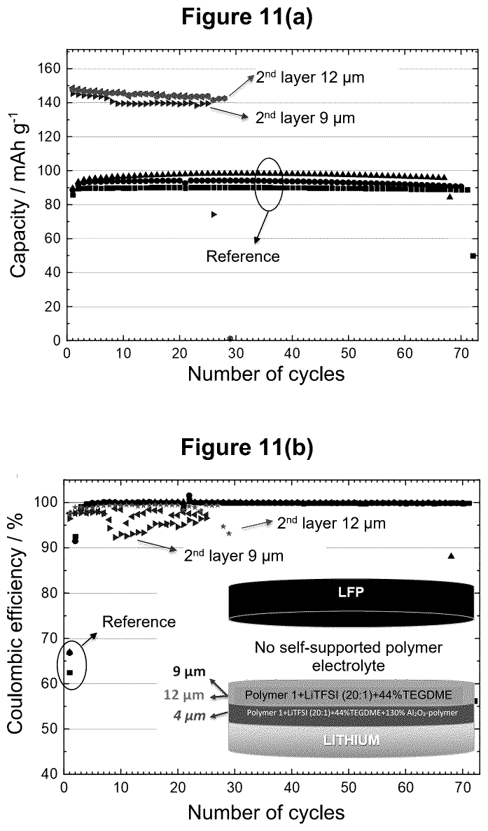

To ensure the relevance of having a second adhesive layer on the lithium surface, a particular cell assembly was used without adding self-supported electrolyte. The inset scheme in FIG. 11(b) shows the assembly tested. A second layer of Polymer 1 with TEGDME was deposited on the lithium surface at relatively high thicknesses of 9 and 12 μm (C4-a and C4-b cells in Table 3, respectively). FIG. 11 shows (a) galvanostatic cycling and (b) coulombic efficiencies obtained at 50° C. and C/3 for LFP/polymer electrolyte/Li batteries assembled with lithium without modification (reference), then for C4-a and C4-b batteries. The polymer films are not cross-linked. The difference in capacity is considerable when the self-supported polymer electrolyte is removed, which causes a lot of resistance and interface problems in the battery. Discharge capacity in the first cycle is around 145-149 mAh/g for batteries without the polymer electrolyte, compared with 85-90 mAh/g for reference batteries. However, in this case, the interface between the cathode, which has surface defects, and the second layer of Polymer 1 deposited on the lithium surface is not optimal. Indeed, small variations in discharge capacity (FIG. 11(a)) can be observed, but mainly more important variations in coulombic efficiencies (FIG. 11(b)), typical of an interface problem. At this stage, the electrochemical results look more stable with a thicker second polymer layer (12 μm versus 9 μm), but the determining factor remains the optimization of the interface between the surface of this polymer layer and the cathode surface.

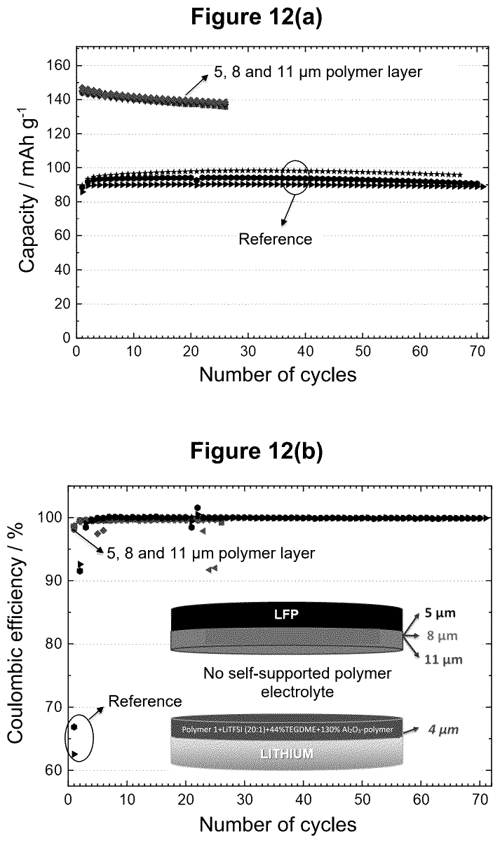

To confirm that the interface between the polymer layer on the anode and the cathode surface is not optimal and is responsible for the variations in coulombic efficiencies, a layer of TEGDME-free Polymer 1 was deposited on the cathode surface. The inset scheme in FIG. 12(b) shows the assembly tested. Three different polymer layer thicknesses of 5, 8 and 11 μm were used (C5-a, C5-b and C5-c cells in Table 3, respectively). It should be noted that for these cells, there is only one layer of Polymer 1+Al₂O₃-polymer on the lithium surface. The polymer films are not cross-linked. FIG. 12 shows (a) galvanostatic cycling and (b) coulombic efficiencies obtained at 50° C. and C/3 for these batteries as well as for the references for comparison. The electrochemical results are remarkable: the three cells are so reproducible that there is virtually no difference in their cycling (FIG. 12(a)). Initial discharge specific capacity is around 145 mAh/g. A gradual drop in capacity is observed, but seems to stabilize as cycling progresses. Coulombic efficiencies close to 99% are achieved in the first cycle, which is much better than the 62% to 66% for reference cells. It is important to note that the thickness of the cathode deposit (5, 8 or 11 μm) has no influence on electrochemical cycling under the tested conditions.

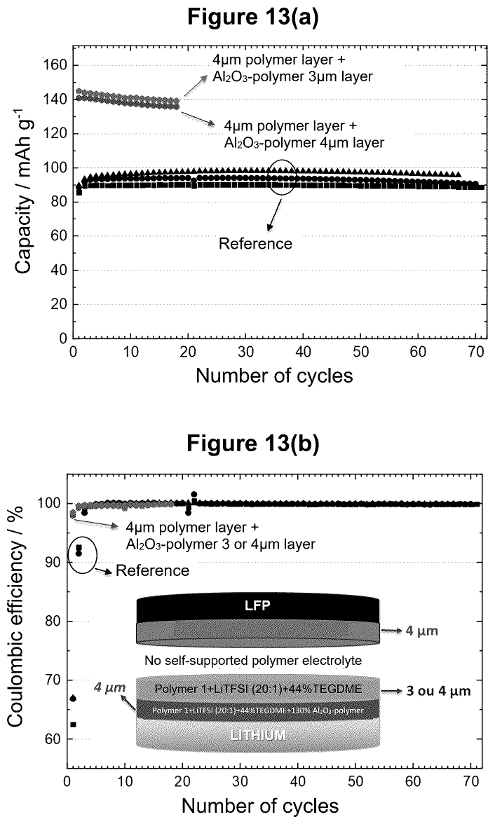

Finally, a last series of tests was carried out by reducing the thickness of the polymer layer on the cathode, since it seemed to have very little influence on cycling stability. In addition, to promote cohesion between the cathode and lithium anode, a second layer of Polymer 1+TEGDME of 3 or 4 μm was deposited on the lithium (cells C6-a and C6-b in Table 3, respectively). The polymer films are not crosslinked. The configuration of these cells is as shown in the inset of FIG. 13(b). The galvanostatic cyclings and coulombic efficiencies obtained at 50° C. and C/3 for these batteries and for the references are shown in FIGS. 13(a) and 13(b). The cyclings are very similar to those obtained in FIG. 12, and perfectly demonstrate the usefulness of depositing thin layers directly on the surface of the cathode and anode to avoid a self-supported polymer electrolyte. Furthermore, in this cell configuration, the lithium possesses the layer rich in Al₂O₃-polymer that enabled stabilization of the lithium.

(e) Modified Electrodes (One Layer without Crosslinking) (FIG. 4(a)-Type Cell)

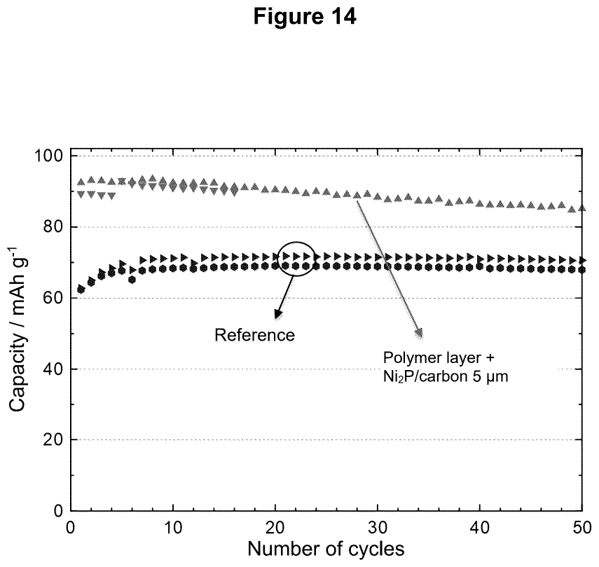

As mentioned above in procedure 2 of Example 2(b)(iii), loadings of inorganic compounds different from Al₂O₃-polymer were also used. A carbon/metal (M) mixture was tested with the aim of forming a Li-M alloy during lithium plating from the cathode to the lithium anode. Carbon is also used for electron conduction in the polymer layer. By way of example, two metals were tested (namely Sn and Zn) as well as a nickel phosphide Ni₂P. Only one type of carbon was tested, but others could be used. FIG. 14 shows the galvanostatic cyclings obtained at 50° C. and C/3 for LFP/polymer electrolyte/Li batteries assembled with lithium without modification (reference), then with lithium having a 5 μm layer of polymer 1 with 30% Ni₂P and 17% carbon (layer B4 in Table 2). The polymer films are not crosslinked. This is a first result, but it confirms that the concept works. We can see an increase in initial capacity compared with reference batteries. However, a progressive drop in capacity can be observed as cycling progresses. This type of layer could benefit from a cell configuration such as those shown in FIGS. 4(d) to 4(f), particularly the one in FIG. 4(f) corresponding to the C6 (a or b) cell shown above, where Al₂O₃-polymer could be replaced by the present carbon/metal mixture.

### Example 4—Surface-Modified Electrodes with Spray-Applied Second Layer and Electrochemical Properties

Other cells according to the invention in a configuration as shown in FIG. 4(f). The first thin layer of inorganic compound in a polymer, however, consists of Polymer 1 and unmodified alumina (Al₂O₃). The second thin layer on lithium is applied by spray in a very thin layer and comprises Polymer 2 rather than Polymer 1 and does not include a plasticizer. The cells also comprise a layer of different thickness of Polymer 1 with a lithium salt and a plasticizer, but without ceramics on the cathode surface. Several batteries were prepared for each to be tested in parallel.

### (a) Manufacturing of Cells C7 to C9

For Cell C7, the procedure is as follows:

Cathode: Ink A7 prepared in Example 2 is applied by doctor-blade onto the surface of an LFP cathode, as described in Example 3(a), so as to achieve a thickness of 40 μm after crosslinking. Once coated, the cathode is left in a fume hood for 5 minutes, then in an airtight box under nitrogen for 5 minutes, and then cross-linked under UV light for 10 minutes.

Anode (first layer): Ink B5-a obtained in Example 2 is applied by doctor-blade onto the surface of a lithium film. The coating is dried for 5 minutes in a fume hood, then for 5 minutes at 50° C. in an oven before the next step. The thickness of the dry deposit is approximately 8-9 μm.

Anode (second layer): The solution obtained for Ink A9 as prepared in Example 2 is sprayed under an fume hood onto the surface of the first layer on the lithium with an argon pressure of 60 psi at a distance of about 30 cm and by making two passes over the surface of the Li. Finally, the modified lithium foil is dried for 5 minutes in a fume hood at 50° C. The resulting layer is very thin (close to 1 μm) but could not be precisely measured.

The free surface of the polymer on the cathode is then applied on the polymer surface of the second layer on the anode. The resulting multi-layer material is pressed together and pouch-type batteries are formed from this material.

The Cell C8 is prepared as for the Cell C7, by applying a 30 μm layer on the cathode rather than 40 μm. Ink B5-a is also replaced by Ink B5-b resulting in a layer thickness of around 7-8 μm.

Cell C9 is prepared in the same way as Cell C7, where a 20 μm layer on the cathode rather than 40 μm.

TABLE 4
Composition of the cells (elements in order)^{a}

| | | | Polymer | Polymer | |
|---|---|---|---|---|---|
| | | Composite | layer | layer | |
| Cell | Anode | layer | (anode) | (cathode) | Cathode^{b} |
| C7 | Lithium | B5-a (8-9 μm) | A9^{c} | A7 (40 μm) | LFP |
| C8 | Lithium | B5-b (7-8 μm) | A9^{c} | A7 (30 μm) | LFP |
| C9 | Lithium | B5-a (8-9 μm) | A9^{c} | A7 (20 μm) | LFP |

^{a}The composition of layers A7, A9 and B5(a and b) is defined in Example 2.
^{b}Composition of the LFP cathode is defined in Example 3(a).
^{c}Ultra-thin layer (thickness not measured)

(b) Electrochemical Results for Cells C₇ to C₉

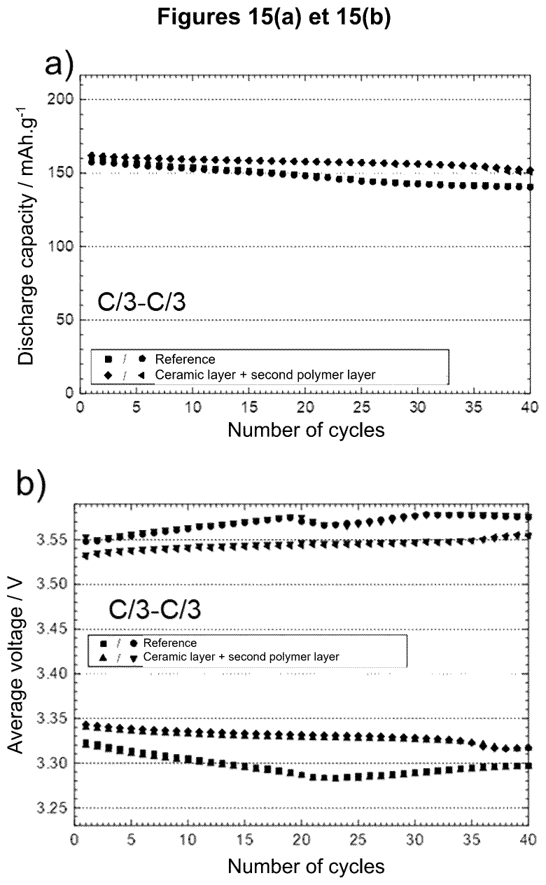

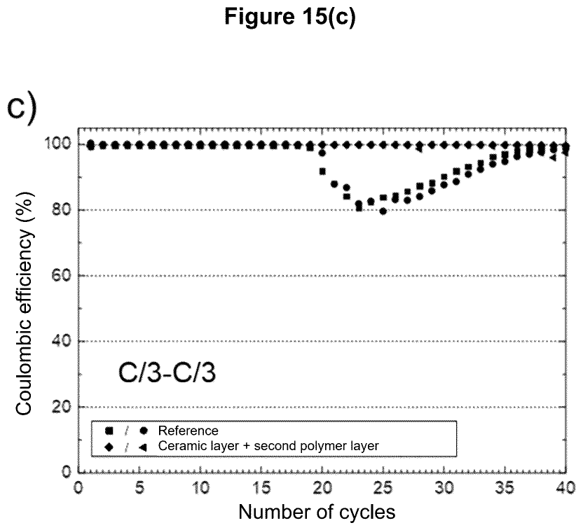

FIGS. 15 to 17 show the electrochemical results obtained during cycling of Cells C7 to C9, compared with an LFP/polymer electrolyte/Li cell assembled with lithium without modification (reference).

FIG. 15(a) shows that Cell C7 is more stable during cycling than the reference cell. This aspect is even more apparent in FIG. 15(c), where a marked drop in coulombic efficiency is observed around the 20^{th} cycle for reference cells, whereas it remains stable for C7 cells. FIG. 15(b) also shows a higher average voltage for C7 cells compared with the reference cells.

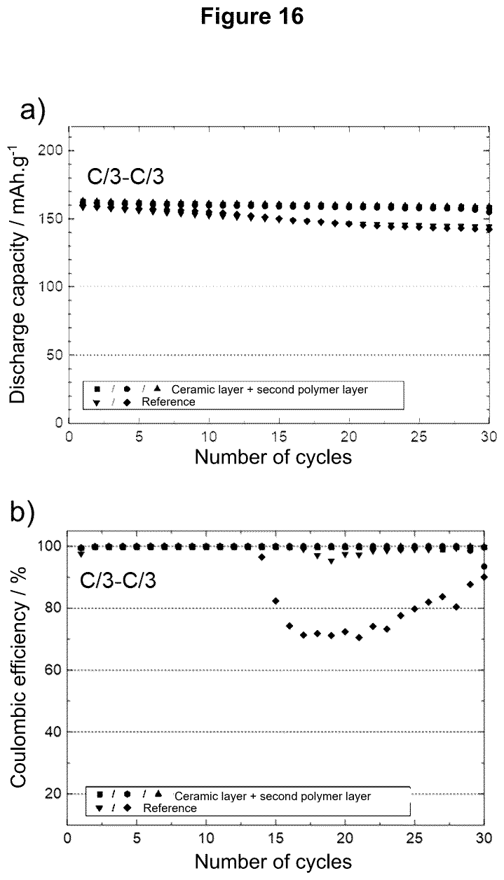

FIGS. 16(a) and 16(b) show cycling stability and coulombic efficiency results for C8 cells that are relatively similar to those obtained for C7 cells.

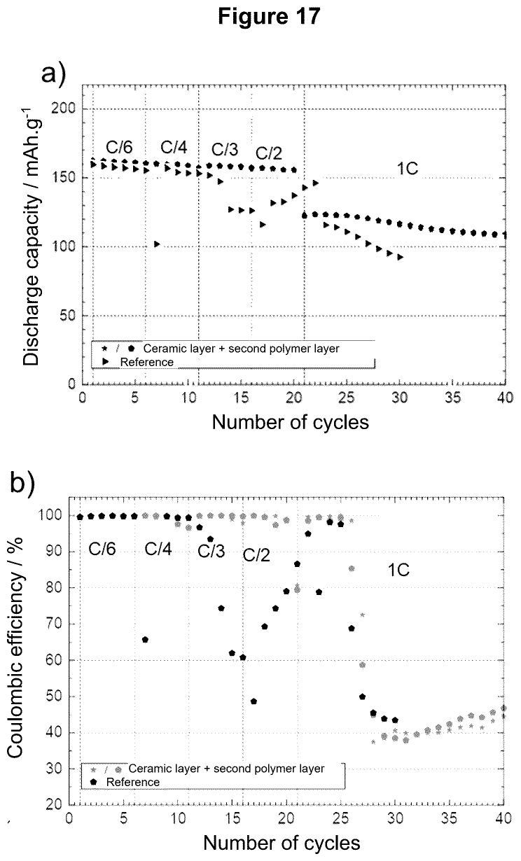

FIG. 17 shows the capacity rate results obtained with C9 cells for 5 cycles at each of the cycling rates C/6, C/4, C/3, C/2 and 1C. A greater stability can be observed for the C9 cells compared to the reference cell, particularly with increasing cycling rate.

### Example 5—Pretreated Electrodes with Modified Surface and Electrochemical Properties

An organic, inorganic or metallic pretreatment of the surface of the metal electrode film (in this case lithium) can also be carried out to form a pretreatment layer, which can consist of the formation of a passivation layer, the formation or deposition of a compound, an organic or inorganic salt, or an alloy with a metal different from that of the electrode film.

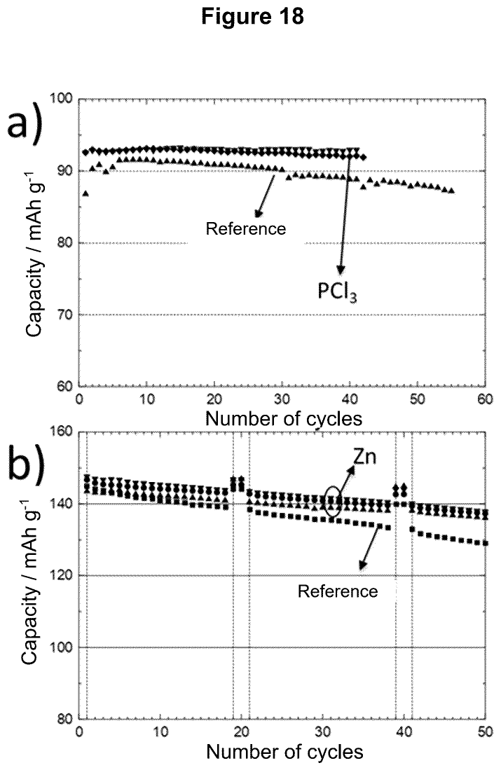

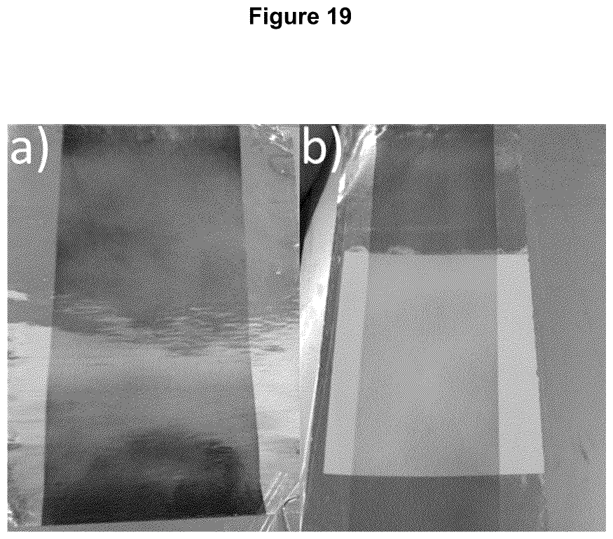

Examples of deposition of a Polymer 1+Al₂O₃-polymer layer (ink B3) have been carried out on various lithium films having received a pretreatment. FIG. 18 shows the galvanostatic cyclings obtained at 50° C. in C/3 (a) and C/6 (b) for LFP/polymer electrolyte/Li batteries assembled with lithium without modification (reference), and with lithiums pretreated with (a) an inorganic molecule (PCl₃) and (b) a thin metal layer (Zn). These lithiums showed that they could help stabilize the cycling. The aim is to have cumulative effects with the polymer+inorganic compound layer and possibly a second layer. So, a first pretreatment to passivate the lithium surface and increase lithium diffusion on its surface, followed by deposition of an anti-dendrite polymer and enabling adhesion to the solid electrolyte (polymer or ceramic type) is recommended. FIG. 19 shows photographs of lithium strips that have received (a) a treatment with PCl₃ and (b) treatment with PCl₃ followed by a polymer 1+Al₂O₃-polymer deposition. The first PCl₃ deposit is very uniform and gives a light brown color (see FIG. 19(a)). The integrity and quality of this first deposit are not affected by the deposition of the polymer 1+Al₂O₃-polymer layer, as shown in FIG. 19(b).

Several modifications could be made to any of the above-described embodiments without departing from the scope of the present invention as contemplated. The references, patents or scientific literature documents referred to herein are incorporated by reference in their entirety and for all purposes.

What is claimed is:

1. Electrode comprising an electrode film modified with a first thin layer and a second thin layer, wherein:
the electrode film comprises a first and a second surface, the first surface being optionally pretreated;
the first thin layer comprises an inorganic compound in a crosslinked or non-crosslinked solvating polymer and optionally an ionic salt and/or un plasticizer, the first thin layer being disposed on the first surface of the electrode film and having an average thickness of about 15 μm or less, the weight ratio “inorganic compound:solvating polymer” in the first thin layer is in the range from about 1:20 to about 20:1; and
the second thin layer comprises a crosslinked or non-crosslinked solvating polymer, an ionic salt and optionally a plasticizer, the second thin layer being disposed on the first thin layer and having an average thickness of about 15 μm or less;
wherein the solvating polymer of the first layer is identical to or different from the solvating polymer of the second layer.

2-3. (canceled)

4. The electrode of claim 1, wherein the electrode film is a current collector, for example comprising an electron-conducting solid support, such as a metal foil or grid (such as copper, nickel, etc.), a carbon or carbon-containing film (such as carbon paper, self-supported graphene, etc.), or other solid support (polymer, glass, etc.) comprising an electron-conducting layer (such as a current collector print).

5. The electrode of claim 1, wherein the electrode film comprises a metal film, for example comprising lithium, preferably lithium comprising less than 1000 ppm (or less than 0.1% by weight) of impurities, or an alloy comprising lithium, preferably an alloy of lithium and an element selected from alkali metals other than lithium (such as Na, K, Rb, and Cs), alkaline earth metals (such as Mg, Ca, Sr, and Ba), rare earth metals (such as Sc, Y, La, Ce, Pr, Nd, Sm, Eu, Gd, Tb, Dy, Ho, Er, Tm, Yb, Lu), zirconium, copper, silver, bismuth, cobalt, manganese, zinc, aluminum, silicon, tin, antimony, cadmium, mercury, lead, molybdenum, iron, boron, indium, thallium, nickel and germanium (e.g. Zr, Cu, Ag, Bi, Co, Zn, Al, Si, Sn, Sb, Cd, Hg, Pb, Mn, B, In, Tl, Ni, or Ge), the alloy preferably comprising at least 75% by weight of lithium, or between 85% and 99.9% by weight of lithium.

6-8. (canceled)

9. The electrode of claim 1, wherein the electrode film further comprises a pretreatment layer on the first surface, being in contact with the first thin layer, preferably the pretreatment layer comprises a compound selected from a silane, a phosphonate, a borate, an organic salt or compound, a carbon (such as graphite, graphene, etc.), an inorganic salt or compound (such as LiF, Li₃N, Li₃P, LiNO₃, Li₃PO₄, etc.), or a thin layer of an element different from a metal of the electrode film or forming an alloy therewith at the surface (such as an element defined in claim 7), said pretreatment layer having an average thickness of less than 5 μm, or less than 3 μm, or less than 1 μm, or less than 500 nm, or less than 200 nm, or less than 100 nm, or less than 50 nm, and/or the first surface of the electrode film is pretreated by stamping.

10-12. (canceled)

13. The electrode of claim 1, wherein the inorganic compound is in particle form (e.g. spherical, rod-shaped, needle-shaped, etc.), the average particle size being for example less than 1 μm, or less than 500 nm, or less than 300 nm, or less than 200 nm, or between 1 nm and 500 nm, or between 10 nm and 500 nm, or between 50 nm and 500 nm, or between 100 nm and 500 nm, or between 1 nm and 300 nm, or between 10 nm and 300 nm, or between 50 nm and 300 nm, or between 100 nm and 300 nm, or between 1 nm and 200 nm, or between 10 nm and 200 nm, or between 50 nm and 200 nm, or between 100 nm and 200 nm, or between 1 nm and 100 nm, or between 10 nm and 100 nm, or between 25 nm and 100 nm, or between 50 nm and 100 nm.

14. (canceled)

15. The electrode of claim 13, wherein the inorganic compound comprises a ceramic or the inorganic compound is selected from Al₂O₃, Mg₂B₂O₅, Na₂O·2B₂O₃, xMgO·yB₂O₃·zH₂O, TiO₂, ZrO₂, ZnO, Ti₂O₃, SiO₂, Cr₂O₃, CeO₂, B₂O₃, B₂O, SrBi₄Ti₄O₁₅, LLTO, LLZO, LAGP, LATP, Fe₂O₃, BaTiO₃, γ-LiAlO₂, a metal/carbon mixture (such as Sn+C, Zn+C, Ni₂P+C), molecular sieves and zeolites (e.g., of aluminosilicate, of mesoporous silica), sulfide ceramics (like Li₇P₃S₁₁), glass ceramics (such as LIPON, etc.), and other ceramics, and combinations thereof.

16. (canceled)

17. The electrode of claim 13, wherein the particles of the inorganic compound further comprise organic groups covalently grafted on their surface, for example, said groups being selected from crosslinkable groups (such as organic groups comprising acrylate functions, methacrylate functions, vinyl functions, glycidyl functions, mercapto functions, etc.), aryl groups, alkylene oxide or poly(alkylene oxide) groups, and other organic groups, or a combination thereof, optionally comprising a spacer group between the organic groups and the particles of inorganic compound, the grafted organic groups preferably comprising poly(alkylene oxide) chains attached to the inorganic compound particles by a spacer group, and/or the spacer group preferably being selected from silane or halogenated silane, phosphonate, carboxylate, catechol, (meth)acrylate or poly(meth)acrylate, alkylene or polyalkylene groups, and combinations thereof.

18-19. (canceled)

20. The electrode of claim 13, wherein the inorganic compound particles have a small specific surface area (for example, less than 80 m²/g, or less then 40 m²/g), and/or the “inorganic compound:solvating polymer” weight ratio in the first thin layer is in the range from about 2:5 to about 4:1, or from about 2:5 to about 2:1, or from about 1:2 to about 2:1, or from about 4:5 to about 2:1, or from about 1:1 to about 2:1, or from about 4:5 to about 3:2.

21. (canceled)

22. The electrode of claim 13, wherein the inorganic compound particles have a high specific surface area (for example, of 80 m²/g or more, or of 120 m²/g or more), and/or the “inorganic compound:solvating polymer” weight ratio in the first thin layer is in the range from about 1:20 to about 2:1, or from about 2:5 to about 2:1, from about 2:5 to about 6:5, or from about 1:20 to about 6:5, or from about 2:5 to about 1:1, or from about 1:20 to about 1:1, or from about 2:5 to about 4:5, or from about 1:20 to about 4:5.

23. (canceled)

24. The electrode of claim 1, wherein:
the average thickness of the first thin layer is between about 0.5 μm and about 15 μm, or between about 1 μm and about 15 μm, or between about 1 μm and about 12 μm, or between about 0.5 μm and about 10 μm, or between about 1 μm and about 10 μm, or between about 2 μm and about 8 μm, or between about 2 μm and about 7 μm, or between 2 μm and about 5 μm; and/or
the average thickness of the second thin layer is between about 50 nm and about 15 μm, or between about 0.1 μm and about 15 μm, or between about 0.5 μm and about 15 μm, or between about 1 μm and about 15 μm, or between about 1 μm and about 12 μm, or between about 0.5 μm and about 10 μm, or between about 1 μm and about 10 μm, or between about 2 μm and about 8 μm, or between about 2 μm and about 7 μm or between about 2 μm and about 5 μm, or between about 50 nm and about 5 μm, or between about 0.1 μm and about 2 μm; and/or
total average thickness of the first and second thin layers is in the range from about 1 μm to about 30 μm, or from about 1 μm to about 25 μm, or from about 5 μm to about 25 μm, or from about 1 μm to about 20 μm, or from about 1 μm to about 16 μm, or from about 2 μm to about 12 μm, or from about 3 μm to about 15 μm, or from about 3 μm to about 12 μm, or from about 4 μm to about 15 μm, or from about 4 μm to about 12 μm.

25-26. (canceled)

27. The electrode of claim 1, wherein the solvating polymer is selected from linear or branched polyether polymers (e.g. PEO, PPO, or EO/PO copolymer), poly(dimethylsiloxanes), poly(alkylene carbonate), poly(alkylene sulfones), poly(alkylene sulfamides), polyurethanes, polyvinyl alcohols, polyacrylonitriles, poly(methyl methacrylates), and copolymers thereof, optionally comprising crosslinked units derived from crosslinkable functions (such as acrylate functions, methacrylate functions, vinyl functions, glycidyl functions, mercapto functions, etc.).

28. The electrode of claim 1, wherein at least one of the first and second thin layers further comprises a plasticizer, preferably the first thin layer and the second thin layer further comprise a plasticizer, the plasticizer being for example selected from the liquids of the type glycol diethers (such as tetraethylene glycol dimethyl ether (TEGDME)), carbonate esters (such as propylene carbonate, ethylene carbonate, fluoroethylene carbonate), lactones (such as γ-butyrolactone), adiponitrile, ionic liquids and the like.

29-30. (canceled)

31. The electrode of claim 1, at least one of the first and second thin layers further comprising a lithium salt, preferably the first thin layer and the second thin layer further comprise a lithium salt, the lithium salt being preferably selected from lithium hexafluorophosphate (LiPF₆), lithium bis(trifluoromethanesulfonyl)imide (LiTFSI), lithium bis(fluorosulfonyl)imide (LiFSI), lithium 2-trifluoromethyl-4,5-dicyano-imidazolate (LiTDI), lithium 4,5-dicyano-1,2,3-triazolate (LiDCTA), lithium bis(pentafluoroethylsulfonyl)imide (LiBETI), lithium tetrafluoroborate (LiBF₄), lithium bis(oxalato)borate (LiBOB), lithium nitrate (LiNO₃), lithium chloride (LiCl), lithium bromide (LiBr), lithium fluoride (LiF), lithium perchlorate (LiClO₄), lithium hexafluoroarsenate (LiAsF₆), lithium trifluoromethanesulfonate (LiSO₃CF₃) (LiTf), lithium fluoroalkylphosphate Li[PF₃(CF₂CF₃)₃] (LiFAP), lithium tetrakis(trifluoroacetoxy)borate Li[B(OCOCF₃)₄] (LiTFAB), lithium bis(1,2-benzenediolato(2-)-O,O′)borate Li[B(C₆O₂)₂] (LBBB), and a combination thereof.

32-33. (canceled)

34. The electrode of claim 1, further comprising a current collector in contact with the second surface of the electrode film.

35. Electrochemical cell comprising a negative electrode and a positive electrode, wherein at least one of the negative electrode and the positive electrode is as defined in claim 1, preferably the negative electrode is as defined in claim 1 and the positive electrode comprises a film of positive electrode material comprising a positive electrode electrochemically active material, optionally a binder, and optionally an electronically conductive material.

36. (canceled)

37. Electrochemical cell of claim 35, wherein the positive electrode electrochemically active material is selected from metal phosphates, lithiated metal phosphates, metal oxides, and lithiated metal oxides, or the positive electrode electrochemically active material is LiM′PO₄ where M′ is Fe, Ni, Mn, Co, or a combination thereof, LiV₃O₈, V₂O₅F, LiV₂O₅, LiMn₂O₄, LiM″O₂, where M″ is Mn, Co, Ni, or a combination thereof (such as NMC, LiMnₓCo_{y}Ni_{z}O₂ with x+y+z=1), Li(NiM′″)O₂ (where M′″ is Mn, Co, Al, Fe, Cr, Ti, Zr, or a combination thereof), elemental sulfur, elemental selenium, elemental iodine, iron(III) fluoride, copper(II) fluoride, lithium iodide, carbon based active materials, organic cathode active materials (such as polyimide, poly(2,2,6,6-tetramethylpiperidinyloxy-4-yl methacrylate) (PTMA), tetra-lithium perylene-3,4,9,10-tetracarboxylate (PTCLi₄), naphthalene-1,4,5,8-tetracarboxylic dianhydride (NTCDA), perylene-3,4,9,10-tetracarboxylic dianhydride (PTCDA), π-conjugated dicarboxylates, and anthraquinone), or a combination of two or more of these materials if compatible with each other, said positive electrode electrochemically active material is preferably in the form of optionally coated particles (e.g. with polymer, ceramic, carbon, or a combination of two or more thereof).

38-39. (canceled)

40. Electrochemical cell of claim 35, wherein the film of positive electrode material comprises a first and a second surfaces, the first surface facing the negative electrode and carrying a third thin layer comprising a solvating polymer and an ionic salt, the third thin layer having an average thickness of about 50 μm or less, about 40 μm or less, or about 30 μm or less, or about 15 μm or less, or is between about 0.5 μm and about 50 μm, or between about 5 μm and about 50 μm, or between about 5 μm and about 40 μm, or between about 0.5 μm and about 15 μm, or between about 1 μm and about 15 μm, or between about 1 μm and about 12 μm, or between about 0.5 μm and about 10 μm, or between about 1 μm and about 10 μm, or between about 2 μm and about 8 μm, or between about 2 μm and about 7 μm, or between 2 μm and about 5 μm, the solvating polymer is preferably as defined in claim 27, the salt is preferably a lithium salt, for example as defined in claim 31, and/or the third thin layer preferably further comprises a plasticizer, for example as defined in claim 28.

41-43. (canceled)

44. Electrochemical cell of claim 35, the electrochemical cell excluding the presence of a solid polymer electrolyte layer.

45. Electrochemical cell of claim 35, the electrochemical cell further comprising a solid electrolyte layer comprising a polymer, a lithium salt, and optionally a ceramic, preferably the electrolyte polymer is selected from linear or branched polyether polymers (for example, PEO, PPO, or EO/PO copolymer), and optionally comprising crosslinkable units), poly(dimethylsiloxanes), poly(alkylene carbonates), poly(alkylene sulfones), poly(alkylene sulfamides), polyurethanes, poly(vinyl alcohols), polyacrylonitriles, poly(methyl methacrylates), and copolymers thereof, the solvating polymer being optionally crosslinked, and/or preferably the lithium salt is selected from lithium hexafluorophosphate (LiPF₆), lithium bis(trifluoromethanesulfonyl)imide (LiTFSI), lithium bis(fluorosulfonyl)imide (LiFSI), lithium 2-trifluoromethyl-4,5-dicyano-imidazolate (LiTDI), lithium 4,5-dicyano-1,2,3-triazolate (LiDCTA), lithium bis(pentafluoroethylsulfonyl)imide (LiBETI), lithium tetrafluoroborate (LiBF₄), lithium bis(oxalato)borate (LiBOB), lithium nitrate (LiNO₃), lithium chloride (LiCl), lithium bromide (LiBr), lithium fluoride (LiF), lithium perchlorate (LiClO₄), lithium hexafluoroarsenate (LiAsF₆), lithium trifluoromethanesulfonate (LiSO₃CF₃) (LiTf), lithium fluoroalkylphosphate Li[PF₃(CF₂CF₃)₃] (LiFAP), lithium tetrakis(trifluoroacetoxy)borate Li[B(OCOCF₃)₄] (LiTFAB), lithium bis(1,2-benzenediolato(2-)-O,O′)borate Li[B(C₆O₂)₂] (LBBB), and a combination thereof.

46-48. (canceled)

49. Electrochemical cell comprising a negative electrode and a positive electrode, wherein:
(a) the negative electrode comprises a negative electrode film comprising a first and a second surface, the first surface being optionally pretreated, wherein said negative electrode comprises a first thin layer comprising an inorganic compound in a crosslinked or non-crosslinked solvating polymer and optionally an ionic salt and/or a plasticizer, the first thin layer being disposed on the first surface of the negative electrode film and having an average thickness of about 15 μm or less, the “inorganic compound:solvating polymer” weight ratio in the first thin layer is in the range of about 1:20 to about 20:1; and
(b) the negative electrode comprises a second thin layer comprising a crosslinked or non-crosslinked solvating polymer, an ionic salt and optionally a plasticizer, the second thin layer being disposed on the first thin layer and having an average thickness of about 15 μm or less, wherein the solvating polymer of the first layer is the same as or different from the solvating polymer of the second layer; and/or
the positive electrode comprises a positive electrode material film comprising a positive electrode electrochemically active material, optionally a binder, and optionally an electronically conductive material, the positive electrode material film comprising a first and a second surface, the first surface facing the negative electrode and carrying a third thin layer comprising a crosslinked or non-crosslinked solvating polymer, an ionic salt, the third thin layer having an average thickness of about 50 μm or less, or about 15 μm or less;
wherein the electrochemical cell excludes the presence of an additional solid polymer electrolyte layer, preferably the second thin layer being present.

50-52. (canceled)

53. Electrochemical cell of claim 49, comprising the third thin layer.

54-57. (canceled)

58. Electrochemical cell of claim 49, wherein the negative electrode film is a current collector, for example comprising an electron-conducting solid support, such as a metal foil or grid (such as copper, nickel, etc.), a carbon or carbon-containing film (such as carbon paper, self-supported graphene, etc.), or other solid support (polymer, glass, etc.) comprising an electron-conducting layer (such as a current collector print).

59. Electrochemical cell of claim 49, wherein the negative electrode film comprises a metal film, preferably the metal film comprises lithium comprising less than 1000 ppm (or less than 0.1% by weight) of impurities, for example comprising lithium or an alloy comprising lithium, preferably an alloy of lithium and an element selected from alkali metals other than lithium (such as Na, K, Rb, and Cs), alkaline earth metals (such as Mg, Ca, Sr, and Ba), rare earth metals (such as Sc, Y, La, Ce, Pr, Nd, Sm, Eu, Gd, Tb, Dy, Ho, Er, Tm, Yb, Lu), zirconium, copper, silver, bismuth, cobalt, manganese, zinc, aluminum, silicon, tin, antimony, cadmium, mercury, lead, molybdenum, iron, boron, indium, thallium, nickel and germanium (e.g. Zr, Cu, Ag, Bi, Co, Zn, Al, Si, Sn, Sb, Cd, Hg, Pb, Mn, B, In, Tl, Ni, or Ge), the alloy preferably comprising at least 75% by weight of lithium, or between 85% and 99.9% by weight of lithium.

60-62. (canceled)

63. Electrochemical cell of claim 49, wherein the negative electrode film further comprises a pretreatment layer on the first surface, being in contact with the first thin layer, preferably the pretreatment layer comprises a compound selected from a silane, a phosphonate, a borate, an organic salt or compound, a carbon (such as graphite, graphene, etc.), an inorganic salt or compound (such as LiF, Li₃N, Li₃P, LiNO₃, Li₃PO₄, etc.), or a thin layer of an element different from a metal of the negative electrode film, or forming an alloy therewith at the surface (such as an element defined in claim 55), said pretreatment layer having an average thickness of less than 5 μm or less than 3 μm or less than 1 μm or less than 500 nm, or less than 200 nm, or less than 100 nm, or less than 50 nm, or the first surface of the negative electrode film is pretreated by stamping.

64-66. (canceled)

67. Electrochemical cell of claim 49, wherein the inorganic compound is in the form of particles (e.g. spherical, rod-shaped, needle-shaped, etc.) the particles average size being preferably of less than 1 μm less than 500 nm, or less than 300 nm, or less than 200 nm, or between 1 nm and 500 nm, or between 10 nm and 500 nm, or between 50 nm and 500 nm, or between 100 nm and 500 nm, or between 1 nm and 300 nm, or between 10 nm and 300 nm, or between 50 nm and 300 nm, or between 100 nm and 300 nm, or between 1 nm and 200 nm, or between 10 nm and 200 nm, or between 50 nm and 200 nm, or between 100 nm and 200 nm, or between 1 nm and 100 nm, or between 10 nm and 100 nm, or between 25 nm and 100 nm, or between 50 nm and 100 nm.

68. (canceled)

69. Electrochemical cell of claim 67, wherein the inorganic compound comprises a ceramic, or the inorganic compound is selected from Al₂O₃, Mg₂B₂O₅, Na₂O₂B₂O₃, xMgO·yB₂O₃·zH₂O, TiO₂, ZrO₂, ZnO, Ti₂O₃, SiO₂, Cr₂O₃, CeO₂, B₂O₃, B₂O, SrBi₄Ti₄O₁₅, LLTO, LLZO, LAGP, LATP, Fe₂O₃, BaTiO₃, γ-LiAlO₂, a metal/carbon mixture (such as Sn+C, Zn+C, Ni₂P+C), molecular sieves and zeolites (e.g., of aluminosilicate, of mesoporous silica), sulfide ceramics (like Li₇P₃S₁₁), glass-ceramics (such as LIPON, etc.), and other ceramics, as well as their combinations.

70. (canceled)

71. Electrochemical cell of claim 67, wherein the particles of the inorganic compound further comprise organic groups covalently grafted onto their surface, for example, said groups being selected from crosslinkable groups (such as organic groups comprising acrylate functions, methacrylate functions, vinyl functions, glycidyl functions, mercapto functions, etc.), aryl groups, alkylene oxide or poly(alkylene oxide) groups, and other organic groups, or a combination thereof, optionally comprising a spacer group between the organic groups and the particles of the inorganic compound, preferably the grafted organic groups comprise poly(alkylene oxide) chains attached to the inorganic compound particles by a spacer group, and/or preferably the spacer group is selected from silane or halogenated silane, phosphonate, carboxylate, catechol, (meth)acrylate or poly(meth)acrylate, alkylene or polyalkylene groups, and combinations thereof.

72-73. (canceled)

74. Electrochemical cell of claim 67, wherein the inorganic compound particles have a small specific surface area (for example, less than 80 m²/g, or less than 40 m²/g), and/or the “inorganic compound:solvating polymer” weight ratio in the first thin layer is in the range from about 2:5 to about 4:1, or from about 2:5 to about 2:1, or from about 1:2 to about 2:1, or from about 4:5 to about 2:1, or from about 1:1 to about 2:1, or from about 4:5 to about 3:2.

75. (canceled)

76. Electrochemical cell of claim 67, wherein the inorganic compound particles have a high specific surface area (e.g. 80 m²/g and above, or 120 m²/g and above), and/or the “inorganic compound:solvating polymer” weight ratio in the first thin layer is in the range from about 1:20 to about 2:1, or from about 2:5 to about 2:1, from about 2:5 to about 6:5, or from about 1:20 to about 6:5, or from about 2:5 to about 1:1, or from about 1:20 to about 1:1, or from about 2:5 to about 4:5, or from about 1:20 to about 4:5.

77. (canceled)

78. Electrochemical cell of claim 49, wherein:
the average thickness of the first thin layer is between about 0.5 μm and about 15 μm, or between about 1 μm and about 15 μm, or between about 1 μm and about 12 μm, or between about 0.5 μm and about 10 μm, or between about 1 μm and about 10 μm, or between about 2 μm and about 8 μm, or between about 2 μm and about 7 μm, or between 2 μm and about 5 μm; and/or
the average thickness of the second thin layer is between about 50 nm and about 15 μm or between about 0.1 μm and about 15 μm, between about 0.5 μm and about 15 μm, or between about 1 μm and about 15 μm, or between about 1 μm and about 12 μm, or between about 0.5 μm and about 10 μm, or between about 1 μm and about 10 μm, or between about 2 μm and about 8 μm, or between about 2 μm and about 7 μm, or between 2 μm and about 5 μm or between 50 nm and about 5 μm or between about 0.1 μm and about 2 μm; and/or
the second thin layer is present and the total average thickness of the first and second thin layers is in the range from about 1 μm to about 30 μm or from about 1 μm to about 25 μm, or from about 5 μm to about 25 μm or from about 1 μm to about 20 μm, or from about 1 μm to about 16 μm, or from about 2 μm to about 12 μm or from about 3 μm to about 15 μm or from about 3 μm to about 12 μm, or from about 4 μm to about 15 μm or from about 4 μm to about 12 μm; and/or
the average thickness of the third thin layer is about 40 μm or less, or about 30 μm or less, or about 15 μm or less, or is between about 0.5 μm and about 50 μm or between about 5 μm and about 50 μm, or between about 5 μm and about 40 μm, or between about 0.5 μm and about 15 μm, or between about 1 μm and about 15 μm or between about 1 μm and about 12 μm or between about 0.5 μm and about 10 μm, or between about 1 μm and about 10 μm, or between about 2 μm and about 8 μm, or between about 2 μm and about 7 μm, or between 2 μm and about 5 μm; and/or
the second thin layer and the third thin layer are present and the total average thickness of the first, second and third thin layers is in the range from about 3 μm to about 60 μm, or from about 10 μm to about 50 μm, or from about 15 μm to about 30 μm, or from about 3 μm to about 30 μm, or from about 3 μm to about 25 μm, or from about 5 μm to about 25 μm or from about 5 μm to about 20 μm or from about 8 μm, to about 15 μm or from about 8 μm to about 12 μm, or from about 5 μm to about 15 μm or from about 5 μm to about 12 μm, or from about 5 μm to about 15 μm, or from about 9 μm to about 15 μm.

79-82. (canceled)

83. Electrochemical cell of claim 49, wherein the solvating polymer is independently selected from linear or branched polyether polymers (e.g. PEO, PPO, or EO/PO copolymer), poly(dimethylsiloxanes), poly(alkylene carbonates), poly(alkylene sulfones), poly(alkylene sulfamides), polyurethanes, poly(vinyl alcohols), polyacrylonitriles, poly(methyl methacrylates), and copolymers thereof, optionally comprising crosslinked units derived from crosslinkable functions (such as acrylate functions, methacrylate functions, vinyl functions, glycidyl functions, mercapto functions, etc.).

84. Electrochemical cell of claim 49, wherein at least one of the first and second thin layers further comprises a plasticizer, preferably the first thin layer and the second thin layer further comprise a plasticizer, the third thin layer optionally further comprising a plasticizer, the plasticizer is preferably selected from liquids of the type glycol diethers (such as tetraethylene glycol dimethyl ether (TEGDE)), carbonate esters (such as propylene carbonate, ethylene carbonate, fluoroethylene carbonate), lactones (such as γ-butyrolactone), adiponitrile, ionic liquids and the like.

85-87. (canceled)

88. Electrochemical cell of claim 49, at least one of the first, second and third thin layers further comprises a lithium salt, preferably the first, second and third thin layers further comprise a lithium salt, the lithium salt being preferably selected from lithium hexafluorophosphate (LiPF₆), lithium bis(trifluoromethanesulfonyl)imide (LiTFSI), lithium bis(fluorosulfonyl)imide (LiFSI), lithium 2-trifluoromethyl-4,5-dicyano-imidazolate (LiTDI), lithium 4,5-dicyano-1,2,3-triazolate (LiDCTA), lithium bis(pentafluoroethylsulfonyl)imide (LiBETI), lithium tetrafluoroborate (LiBF₄), lithium bis(oxalato)borate (LiBOB), lithium nitrate (LiNO₃), lithium chloride (LiCl), lithium bromide (LiBr), lithium fluoride (LiF), lithium perchlorate (LiClO₄), lithium hexafluoroarsenate (LiAsF₆), lithium trifluoromethanesulfonate (LiSO₃CF₃) (LiTf), lithium fluoroalkylphosphate Li[PF₃(CF₂CF₃)₃] (LiFAP), lithium tetrakis(trifluoroacetoxy)borate Li[B(OCOCF₃)₄] (LiTFAB), lithium bis(1,2-benzenediolato(2-)-O,O′)borate Li[B(C₆O₂)₂] (LBBB), and a combination thereof.

89-90. (canceled)

91. Electrochemical cell of claim 49, wherein the negative electrode further comprises a current collector in contact with the second surface of the negative electrode film, and/or the positive electrode further comprises a current collector in contact with the second surface of the positive electrode material film.

92. (canceled)

93. Electrochemical cell of claim 49, wherein the positive electrode electrochemically active material is selected from metal phosphates, lithiated metal phosphates, metal oxides, and lithiated metal oxides, or the positive electrode electrochemically active material is LiM′PO₄ where M′ is Fe, Ni, Mn, Co, or a combination thereof, LiV₃O₈, V₂O₅F, LiV₂O₅, LiMn₂O₄, LiM″O₂, where M″ is Mn, Co, Ni, or a combination thereof (such as NMC, LiMnₓCo_{y}Ni_{z}O₂ with x+y+z=1), Li(NiM′″)O₂ (where M′″ is Mn, Co, Al, Fe, Cr, Ti, Zr, or a combination thereof), elemental sulfur, elemental selenium, elemental iodine, iron(III) fluoride, copper(II) fluoride, lithium iodide, carbon based active materials, organic cathode active materials (such as polyimide, poly(2,2,6,6-tetramethylpiperidinyloxy-4-yl methacrylate) (PTMA), tetra-lithium perylene-3,4,9,10-tetracarboxylate (PTCLi₄), naphthalene-1,4,5,8-tetracarboxylic dianhydride (NTCDA), perylene-3,4,9,10-tetracarboxylic dianhydride (PTCDA), π-conjugated dicarboxylates, and anthraquinone), or a combination of two or more of these materials if compatible with each other, the positive electrode electrochemically active material being preferably in the form of optionally coated particles (e.g. with polymer, ceramic, carbon or a combination of two or more thereof).

94-95. (canceled)

96. Electrochemical accumulator comprising at least one electrochemical cell as defined in claim 35, preferably said electrochemical accumulator is a lithium battery or a lithium-ion battery.

97-99. (canceled)

100. Electrochemical accumulator comprising at least one electrochemical cell as defined in claim 49, preferably said electrochemical accumulator is a lithium battery or a lithium-ion battery.
